(19) United States
(12) Patent Application Publication
(10) Pub. No.: US 2024/0013327 A1
(43) Pub. Date: Jan. 11, 2024

(54) DATA MANAGEMENT SYSTEM FOR USE WITH AGREEMENTS AND DATA DETAILING CONCEPTS, DESIGNS, AND IDEAS

(71) Applicant: Orula Inc., Ottawa (CA)

(72) Inventors: Natalie Raffoul, Ottawa (CA); Jennifer Raoul, Ottawa (CA); Warren Gallagher, Ottawa (CA)

(21) Appl. No.: 18/265,209

(22) PCT Filed: Dec. 4, 2021
(86) PCT No.: PCT/CA2021/051736

§ 371 Date: Jun. 2, 2023

(51) Int. Cl. G06Q 50/18

(52) U.S. Cl. CPC G06Q 50/184

(57) ABSTRACT

Systems and methods for managing an organization's agreements and possible IP assets. The system provides users from the organization a user interface in which to enter ideas, concepts, and/or designs related to one or more projects, which can include products, services, transactions and ideas. These entries can then be stored, managed, and mined as necessary by the organization. In addition, the system allows for the storage of the organization's agreements and for the analysis of such agreements to flag/identify potential issues with such agreements. Machine learning and artificial intelligence-based methods and subsystems can be used to analyze these agreements. Experts in the various relevant fields provide the logic and samples against which the agreements are to be assessed. Multi-tenant embodiments of the system permit organization users, expert users, and third parties to access, modify and/or review data related to the projects.

### TECHNICAL FIELD

The present invention relates to data management. More specifically, the present invention relates to systems and methods for data management in organizations that generate intellectual property (IP) assets.

### BACKGROUND

The innovation revolution of the late 20th and early 21st century has shown that intellectual property, including formal IP assets such as, without limitation, granted patents and pending patent applications, registered trademarks, registered designs, etc. and informal IP assets such as, without limitation, contracts and agreements, trade secrets, open source software, copyright, inventions for which patent protection has not been sought, etc. is valuable and can form one of the major assets for an organization. However, managing and tracking such IP has, previously, been seen as tedious and time-consuming. Managing the ideation process for new products or services that include trade secrets, inventions, trademarks, and other IP developments is frequently handled manually—that is, by an individual or team at an organization trying to keep track of everything using spreadsheets, in-house document filing systems, and their memories. As IP assets get more complex, this process becomes extremely cumbersome. Important information, such as dates of first use or dates of disclosure, can be buried in lengthy email threads.

Additionally, early-stage ideation processes can be particularly difficult for unsophisticated IP generators. They may not know, e.g., details of filing processes, or disclosure requirements, or other important information that may affect their rights. Depending on their level of sophistication and/or funding, they may not seek advice on these issues until time limits have already expired and such ideas may already be known and in the public domain. Accordingly, there would be a benefit to a system that can flag such issues to such users at the first stages of the ideation process.

Similarly, IP licensing agreements and other transactions that may involve IP or resulting in IP assets, such as employment, customer, and confidentiality agreements, are frequently organized by hand. This means that important details, such as renewal dates and specific restrictions, or specific language, may be easily forgotten. There would, accordingly, be a benefit to a system that can flag and compare such important details, and that can track changes between different versions of agreements.

There are, currently, no systems or methods that allow for the easy management of an organization's IP from the ideation stage through development, use, licensing, and (potentially) transfer. Various systems may permit some aspects of the IP management process to be handled electronically, but there is nothing that allows a holistic view of the entire process and that can integrate with an organization's business objectives, i.e., view IP from the perspective of the organization's products or services. There is, therefore, a need for a system that does not require inordinate amounts of time to use and that does not significantly impinge on the time of employees to use and that reduces the costs of working with IP experts, such as lawyers and patent agents.

### SUMMARY

The present invention provides systems and methods for managing an organization's IP assets. The system provides users from the organization with a user interface in which to enter ideas, concepts, and/or designs from which IP assets may result. These entries can then be stored, managed, and mined as necessary by the organization. In addition, the system allows for the storage of the organization's agreements and for the analysis of such agreements to flag/identify potential issues with such agreements. Machine learning and artificial intelligence-based methods and subsystems can be used to analyze these agreements. Experts in the various relevant fields provide the logic and samples by which the agreements are assessed (either as a basis for a rules-based system or to train the artificial intelligence agents).

In a first aspect, this document discloses a system for managing intellectual property rights, said system comprising: a user interface configured to receive input from a user, wherein the information comprises at least one of a transaction document and a data file relating to an idea; a processor for receiving said input from said user interface, the processor comprising: an ideation module for providing information relating to an ideation process, wherein, when said input comprises said data file relating to an idea: said ideation module identifies at least one key word in said at least one data file, said at least one key word being added to said at least one data file by at least one user and said at least one key root word being identified based on predetermined trigger data in said at least one data file, wherein the at least one key word is either: at least a part of a trademark or a term that characterizes an invention based on the idea; and said ideation module causes said user interface to display intellectual property information relating to said at least one key word to said user, wherein said intellectual property information is retrieved from an intellectual property database that stores intellectual property information, a documentation analysis module for identifying at least one of a risk in said transaction document and a change from a previous version of said transaction document, wherein, when said input comprises said transaction document: said documentation analysis module identifies at least one of: a presence of at least one transaction term in a document in the least one file, said at least one transaction term being a match with a term derived from at least one root word in a plurality of key root words, wherein each root word in said plurality is associated with transaction language used in transaction documentation or with a transaction risk that is a consequence of said transaction language; an absence of said at least one transaction term; and said change, and said documentation analysis module causes said user interface to display at least one of: preferred transaction language associated with said at least one transaction term; an indication of said transaction risk based on said presence or said absence of said at least one transaction term; and said change, and a database in communication with said processor, said database being for storing at least: said input; said plurality of key root words; and said at least one key word.

In a second aspect, this document discloses a system for identifying risk in documents comprising: a user interface for uploading at least one file associated with a transaction; a database for storing the least one file and for storing a plurality of key root words, wherein each key root word is associated with transaction language used in transaction documentation or with a transaction risk that is a consequence of said transaction language; a processor for identifying a presence of at least one transaction term in a document in the least one file, said at least one transaction term being a match with a term derived from at least one root word in said plurality of key root words; an absence of said at least one transaction term; and wherein said risk comprises legal risk or intellectual property related risk; said user interface displays preferred transaction language associated with said at least one transaction term whenever said at least one transaction term is identified by said processor in said document; said user interface provides an indication of said transaction risk when said at least one transaction term is identified in the document and when a use of said at least one transaction term in said document does not conform to said preferred transaction language.

In a third aspect, this document discloses a system for managing different versions of transaction documentation, the system comprising: a user interface for receiving and storing in a database a first transaction documentation file, a second transaction documentation file that is a subsequent version of the first transaction documentation file, and a third transaction documentation file, said first transaction documentation file and said second transaction documentation file both being related to a first transaction and said third transaction documentation file being related to a second transaction; a processor for identifying differences in documentation language between said first transaction documentation file and said second transaction documentation file such that documentation language that has been changed from said first transaction documentation file to result in documentation language in said second transaction documentation file is flagged as preferred documentation language; wherein documentation language flagged as preferred documentation language is stored in the database and is associated with a key root word, said preferred documentation language containing a transaction term that is derived from said key root word; and wherein the processor is further for identifying a specific transaction term in the third documentation transaction file and wherein, when said processor identifies said specific transaction term in said third documentation transaction file, the user interface displays at least one preferred documentation language associated with a specific key root word from which the specific transaction term has been derived; wherein said different versions of said transaction documents are used to train a model on preferred documentation language through changes made to documentation transaction files.

In a fourth aspect, this document discloses a system for managing data files relating to ideation, the system comprising: a user interface for receiving at least one data file associated with an idea, said at least one data file providing details regarding said idea; a first database for storing said at least one data file; a processor for identifying at least one key word in said at least one data file, said at least one key word being added to said at least one data file by at least one user and said at least one key root word being identified based on predetermined trigger data in said at least one data file, said at least one key word being related to said idea; a user interface for displaying said intellectual property information relating to said at least one key word, said intellectual property information being retrieved by a search engine based on said at least one key word; wherein the search engine searches and retrieves said intellectual property information from an external database that stores intellectual property information; wherein the at least one key word is either: part of a trademark or a term that characterizes an invention based on the idea.

In another aspect, this document discloses a system for managing data files, the system comprising: a user interface for uploading at least one data file and for reviewing said at least one data file; a server for receiving said at least one data file; and a first database for storing said at least one data file, wherein said at least one data file relates to a project, said project relating to at least one of: an idea; a product; a service; and a transaction, and wherein multiple data files relating to the project are linked to each other within said first database, such that said multiple data files together form a project object.

In another aspect, this document discloses a system for managing transaction documentation, the system comprising: a user interface for uploading a data file related to said transaction documentation and for reviewing said at least one data file; a server for receiving said data file; and a database for storing said data file, wherein, when a defect in said at least one data file is flagged, said system prompts at least one user to resolve said defect.

In another aspect, this document discloses a system for marking projects for review by third parties, the system comprising: a user interface for uploading at least one data file and for reviewing said at least one data file; a server for receiving said at least one data file; a first database for storing said at least one data file; and a second database for storing information for said review, said second database being accessible by said third parties, wherein said at least one data file relates to a project, said project relating to at least one of an idea; a product; a service; and a transaction, wherein said project is managed by an organization, wherein multiple data files relating to a single project are linked to each other within said first database, such that said multiple data files together form a project object, wherein, when a user marks at least a part of said project object for review, a reference to said at least a part of said project object is added to said second database, and wherein, when a user marks said organization for review, a reference to said organization is added to said second database.

In another aspect, this document discloses a system for managing IP assets, said system comprising: a user interface for uploading at least one data file and for reviewing said at least one data file; a server for receiving said at least one data file; and a cloud-based data storage space for storing said at least one data file, wherein metadata related to said at least one data file is also stored in the data storage space, wherein said system further comprises a reporting module for generating a tracking report related to said metadata, said report being presented to a user, and wherein said at least one data file relates to an IP asset.

In another embodiment, this document discloses a system wherein said metadata is at least one of: extracted from said at least one data file and input by a user of said user interface.

In another embodiment, this document discloses a system wherein said at least one data file is linked to at least one other data file to thereby form a project object and wherein said report relates to said project object.

In another aspect, this document discloses a method for generating timeline visualizations, said method comprising: receiving a plurality of dates related to a plurality of milestone events; determining at least one period based on at least one pair of dates, at least one of said at least one pair of dates being one of said plurality of dates; generating a timeline visualization, said timeline visualization being a visual representation of said at least one period.

In another embodiment, this document discloses a method wherein said timeline visualization is interactive.

In another embodiment, this document discloses a method wherein said milestone events are related to an IP asset.

In another embodiment, this document discloses a method wherein the milestone event is related to at least one of: government regulations; an IP asset related deadline; a filing date; a priority date; a date of publication; a product launch date; an implementation date; an expiry of IP related rights; an expiry of license rights; and an expiry of exclusivity rights.

In a further embodiment, this document discloses a system for managing IP assets and data files, said data files being associated with at least one IP asset being managed, the system comprising:
a user interface module for uploading at least one data file and for reviewing said at least one data file;
a server for receiving said at least one data file; and a first database for storing said at least one data file;
a management module for managing said data files and document files, said document files being a specific type of data file;
a document analysis module for analyzing a content of document files;
   wherein
each data file relates to at least one IP asset being managed by said system;
said management module organizes said data files based on user defined project groupings;
data files organized into a specific project grouping are linked to one another and said data files organized into a project grouping forms a project object;
each project grouping relates to at least one of: a specific idea, a specific product, a specific service, and a specific transaction.

In yet a further embodiment, the system further comprises at least one of: a timeline reporting module for generating timelines and timeline-based reports based on data retrieved from said database; a document analysis module for analyzing documents stored in said database; an ideation module for assisting users in documenting ideas such that said ideas are documented in data files stored in said database; a docketing module for tracking dates and deadlines for IP assets being managed; an automated searching module for providing automated searching functions for relevant patent and trademark documentation based on user inputs; a budgeting module for providing cost estimates for specific IP related actions; a reporting module for creating and managing reports on IP assets being managed by said system; and a data extraction module for analyzing documentation stored in said database and for extracting relevant data from said documentation.

In one embodiment, the user is provided with predetermined guidance regarding the IP assets. The database may include preconfigured templates for use by the user, the preconfigured templates relating to at least one IP asset of said at least one corporate organization.

In a further embodiment, the system also is for tracking developments relating to the specific idea, the specific product, the specific service, or the specific transaction.

A further aspect of the present invention provides a system for managing documentation, the system comprising: a user interface module for receiving input from a user; a database storing a plurality of data files, said data files comprising documents; and a management module for managing said data files based at least on input from said user and for creating one or more data rooms based on user input; wherein: data files selected by said user for inclusion in a specific data room are tagged by said management module as being in said specific data room; data files tagged by said management module as being included in said specific data room are accessible to a specific set of designated users external to a predetermined organization; and wherein said designated users are provided permission-based access to said data files in said specific data room, said permission-based access being selected by said user.

In one embodiment, each data file relates to at least one IP asset being managed by the system. As well, for some embodiments, when the user selects a specific grouping of data files for inclusion in the specific data room, data files in the group are tagged by the management module as being in the specific data room, the specific grouping of the data files being based on at least one common attribute of contents in the data files in the specific grouping. It should be clear that, for other embodiments, the at least one common attribute of contents in the data files in the specific grouping is that the contents of the data files in the specific grouping relate to a specific IP asset.

Further embodiments provide that the designated users are selected by the user and that the permission-based access comprises allowing, based on permissions selected by the user, the designated users to perform at least one of: viewing data files in said data room; downloading data files in said data room; editing data files in said data room; removing data files from said data room; and adding data files to said data room.

In another aspect, the system may include any of the following: a document analysis module for analyzing a content of document files; a timeline reporting module for generating timelines and timeline-based reports based on data retrieved from said database; a document analysis module for analyzing documents stored in said database; an ideation module for assisting users in documenting ideas such that said ideas are documented in data files stored in said database; a docketing module for tracking dates and deadlines for IP assets being managed by said system; an automated searching module for providing automated searching functions for relevant patent and trademark documentation based on user inputs; a budgeting module for providing cost estimates for specific IP related actions; a reporting module for creating and managing reports on IP assets being managed by said system; and a data extraction module for analyzing documentation stored in said database and for extracting relevant data from said documentation.

In yet a further embodiment, the data files in the database are organized by the management module in virtual folders, each virtual folder being designated for at least one specific type of documentation. The management module organizes the virtual folders such that at least one virtual folder relates to at least one of corporate documentation; financial documentation; corporate information relating to said predetermined organization; assets; agreements; contracts relating to employees; contracts relating to directors; contracts relating to consulting; capital assets; IP assets; liabilities; employment agreements; corporate records; shareholder information;

For other embodiments, when the user selects a virtual folder for inclusion in a data room, all files in the virtual folder are tagged by the management module as being in the data room.

For further embodiments, based on user input, the management module creates multiple data rooms, each of the multiple data rooms being for a specific transaction relating to the predetermined organization. It should be clear that the designated users for a data room comprise individuals involved in the specific transaction. The individuals involved in the specific transaction may comprise at least one of: lawyers; investors; accountants; venture capitalists; bankers; consultants; intellectual property specialists; specialists in corporate finance; tax specialists; technical subject matter experts; technology transfer specialists; inventors; creators of intellectual property; corporate officers; and government officials.

For other embodiments, the specific transaction relates to at least one of: government tax credits for at least one corporate organization; corporate financing for at least one corporate organization; a public offering of corporate stock in at least one corporate organization; venture capital funding for at least one corporate organization; and legal due diligence on at least one corporate organization.

Yet a further embodiment provides a system where at least one of the one or more data rooms has data files organized into virtual folders. The virtual folders in the at least one of one or more data rooms includes at least one virtual folder for at least one of: data files relating to corporate records; data files relating to shareholder information; data files relating to financial matters; data files relating to employees of said predetermined organization; data files relating to directors of said predetermined organization; and data files relating to capital assets of said predetermined organization.

It should be clear that, for some embodiments, when the user selects data files for inclusion in a specific data room, the user also selects a specific virtual folder in said data room for association with user selected data files and that the management module tags the user selected data files as being in the specific data room in the specific virtual folder.

In one embodiment, the database is stored using a secure cloud-based data storage.

A further aspect of the present invention provides a system for use in managing corporate matters and IP matters for at least one corporate organization, the system comprising:
a user interface module for receiving input from a user;
a database storing a plurality of data files, said data files comprising documents relating to said corporate matters and to said IP matters; and
a management module for managing said data files based at least on input from said user and for organizing said data files based on user input;
wherein
said management modules organizes said data files into virtual folders such that data files in a virtual folder relate to a matter common across said data files in said virtual folder;
said system tracks and manages relevant dates and deadlines for said corporate matters and for said IP matters based on user input.

In one embodiment, the system is useful for permission-based sharing of documentation across multiple organizations. The permission-based sharing of documentation is accomplished by way of at least specific data room, wherein user selected data files tagged by the management module as being included in the at least one specific data room are accessible to a specific set of designated users across multiple organizations. The user shares contents of a specific virtual folder with select designated users by selecting the specific virtual folder as being included in a user specified data room.

In another embodiment, the system automatically analyzes documentation for relevant deadlines and dates to be tracked.

In yet a further embodiment, the user interface provides multiple reports to the user regarding the corporate matters and the IP matters based on data stored in the database wherein a form and content of the reports are based on user input.

In one other aspect, the system analyzes documentation for issues in the content of the documentation and provides suggestions for addressing these issues.

It should be clear that, in yet another aspect, the relevant dates and deadlines relate to an expiry of contract based rights. These contract based rights may be IP based rights.

As a further embodiment, at least one of the multiple reports covers both corporate and IP matters for at least one corporate organization. As a variant, at least one of the multiple reports covers multiple types of IP assets managed by the system. For the corporate and IP matters, the system automatically retrieves data and documentation relating to the corporate and IP matters from at least one online source. The data retrieved from the at least one online source may be included in at least one report provided by the system to the user using the user interface module.

It should be clear that the user may be guided by the system regarding managing the IP matters. The IP assets managed by the system and whose details and deadlines are tracked may be any of: issued patents; unfiled patent applications; filed patent applications; pending patent applications; registered rights to specific ideas; unregistered rights to specific ideas; registered trademarks; pending trademark applications; unregistered trademarks; registered industrial designs; pending industrial design applications; unregistered industrial designs; rights to materials covered by copyright; trade secrets; open source licenses; agreements; contracts; assignments; licenses; licenses covering IP rights; employment agreements; and rights to specific technologies.

In a further embodiment, there is provided a system for managing IP assets and data files, said data files being associated with at least one IP asset being managed, the system comprising: a user interface module for receiving input from a user and for uploading at least one data file and for reviewing said at least one data file; a server for receiving said at least one data file; and a first database for storing said at least one data file, a management module for managing said data files and document files, said document files being a specific type of data file; a document analysis module for analyzing a content of document files; wherein each data file relates to at least one IP asset being managed by said system; said management module organizes said data files based on user defined project groupings; data files organized into a specific project grouping are linked to one another and said data files organized into a project grouping forms a project object; each project grouping relates to at least one of: a specific idea, a specific product, a specific service, and a specific transaction.

In yet a further embodiment, the at least one data file is linked to at least one relevant project object. In another embodiment, the user interface is integrated with at least one third party application on a computing device used by a user, such that data files are uploadable to said system directly from said at least one third party application. Further, each project object is accessible by multiple users.

In a further embodiment, the project object has at least one controlling user and the at least one controlling user designates other users that are permitted to access said project object and to access each data file within said project object. In one variant, the at least one controlling user designates other users that are permitted to modify said project object and to modify each data file within said project object.

In another aspect, the at least one data file is downloadable to a computing device used by a user.

In a further embodiment, at least one issue related to the at least one data file is flagged by a user. For this embodiment, when said at least one issue is flagged, a system notification that prompts at least one user to resolve said at least one issue is generated.

For one implementation, the project object includes at least one of: a data file relating to an intellectual property asset; a data file relating to a product; a data file relating to a service; and a data file relating to a transaction.

It should be noted that, in one aspect, a visual representation of said data files comprising said project object is presented to a user through said user interface.

In yet another implementation, at least a part of said project object is marked by a user for review by a third party, said system further comprising a second database, and wherein, when said at least a part of said project object is marked by said user, a reference to said at least part of said project object is added to said second database.

It should be clear that system may further comprise at least one of: a timeline reporting module for generating timelines and timeline-based reports based on data retrieved from said database; a document analysis module for analyzing documents stored in said database; an ideation module for assisting users in documenting ideas such that said ideas are documented in data files stored in said database; a docketing module for tracking dates and deadlines for IP assets being managed; an automated searching module for providing automated searching functions for relevant patent and trademark documentation based on user inputs; a budgeting module for providing cost estimates for specific IP related actions; a reporting module for creating and managing reports on IP assets being managed by said system; and a data extraction module for analyzing documentation stored in said database and for extracting relevant data from said documentation.

Another embodiment of the present invention details a system for managing IP assets, said system comprising: a user interface for uploading at least one data file and for reviewing said at least one data file; a server for receiving said at least one data file; and a cloud-based data storage space for storing said at least one data file, wherein metadata related to said at least one data file is also stored in the data storage space, wherein said system further comprises a reporting module for generating a tracking report related to said metadata, said report being presented to a user, and wherein said at least one data file relates to an IP asset being managed by said system.

In yet a further embodiment of the present invention, the metadata is at least one of: extracted from said at least one data file and input by a user of said user interface. Of course, the at least one data file is linked to at least one other data file to thereby form a project object and wherein said report relates to said project object.

For a timeline visualization aspect of the present invention, there is provided a method for generating timeline visualizations, said method comprising: receiving a plurality of dates related to a plurality of milestone events; determining at least one period based on at least one pair of dates, at least one of said at least one pair of dates being one of said plurality of dates; generating a timeline visualization, said timeline visualization being a visual representation of said at least one period. It should be clear that the timeline visualization may be interactive and that the timeline visualization displays at least one milestone event. This at least one milestone event may be related to an IP asset.

In another aspect of the present invention, the at least one milestone event relates to at least one of: government regulations; an IP asset related deadline; a filing date; a priority date; a date of publication; a grant date; an approval date; a product launch date; an implementation date; an expiry of IP related rights; an expiry of license rights; and an expiry of exclusivity rights.

As noted above, in another aspect of the present invention, system tracks deadlines for an expiry of licensed IP related rights. It should also be noted that the IP assets referred to above include at least one of: issued patents; unfiled patent applications; filed patent applications; pending patent applications; registered rights to specific ideas; unregistered rights to specific ideas; registered trademarks; pending trademark applications; unregistered trademarks; registered industrial designs; pending industrial design applications; unregistered industrial designs; rights to materials covered by copyright; trade secrets; open source licenses; agreements; contracts; assignments; licenses; licenses covering IP rights; employment agreements; and rights to specific technologies.

In a further embodiment, there is provided a system for managing documentation, the system comprising: a user interface module for receiving input from a user; a database storing a plurality of data files, said data files comprising documentation relating to said corporate matters and to said IP matters; a management module for managing said data files based at least on input from said user and for organizing said data files based on user input; wherein said system provides: contract management functions for managing corporate matters for at least one corporate organization; IP asset management functions for managing IP assets for at least one corporate organization; virtual room functions for providing secure shared access to user selected data files; and secure networked data storage for said data files and for said system.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the present invention;

FIG. 2 is a flowchart detailing a method according to an aspect of the invention;

FIG. 3 is a flowchart detailing a method according to an aspect of the invention;

FIG. 4 is a flowchart detailing a method according to an aspect of the invention;

FIG. 5 is a schematic diagram of a data file logic structure according to another aspect of the present invention;

FIG. 6 is a block diagram of a system according to another aspect of the present invention;

FIGS. 7A, 7B, and 7C are exemplary timeline visualizations that may be generated by the system described herein;

FIG. 8 is a block diagram of a system according to another aspect of the present invention;

FIG. 9 is a flowchart detailing a method of generating timeline visualizations according to another aspect of the present invention;

FIG. 10 is a flowchart detailing a method of resolving defects in data according to another aspect of the present invention;

FIG. 11 is a block diagram of a system according to another aspect of the present invention;

FIG. 12 illustrates a block diagram detailing one embodiment of the present invention;

FIGS. 13-20 show screenshots of a user interface according to one implementation of several embodiments of the present invention; and

FIG. 21 details the integrated offering of one aspect of the present invention.

### DETAILED DESCRIPTION

This document discloses systems and methods for managing data in a corporate environment. More specifically, this document discloses, in one embodiment, a system that provides a single environment for the management of IP assets/intangible assets within a company or organization. The system creates a single environment that allows for contract management and formal IP asset management and that further provides a virtual data room and a secured, cloud-based storage solution for a company or organization. As such, the present invention is suitable for a company or organization that generates intellectual property such as ideas and inventions, designs, copyrights, trademarks, and the like.

It should be noted that the terms organization, company and business may be used interchangeably. A person of skill in the art should understand that, in relation to the inventions disclosed herein, any type of organization, company and business is contemplated as a user of any invention disclosed herein.

As should be understood, the term ‘IP asset’ as used herein, includes both formally protected forms of intellectual property (e.g., without limitation, patents and registered trademarks) and informal forms of intellectual property (e.g., without limitation, contracts and transaction agreements, regardless of whether those contracts specifically relate to the protection and/or licensing of other IP assets; trade secrets; ideas; open source licenses; and other forms of IP that are not formally registered).

In this document, the terms ‘transaction’, ‘transaction document’, ‘contract’, and ‘agreement’ may be used to specifically reference such contracts where relevant, but should not be construed to mean that such contracts are not included in the definition of ‘IP asset’.

This document discloses a system for tracking various attributes of IP assets, including, without limitation, relevant dates, completion status information, and relationships between different IP assets and parties, as well as for storing information, data files, and documents related to the IP assets. Relevant dates include, without limitation, milestone dates, expiry dates, renewal dates, execution dates, dates of partnerships and other collaborations, and any other date that is related to a specific IP asset. As would be clear to the person skilled in the art, the relevant date(s) for any specific asset can depend on the type of IP asset in question and/or the jurisdiction. For example, a priority date may be relevant to a patent application, and thus tracked by the system, while a contract may not have a corresponding ‘priority date’ tracked. As such, different interfaces may be used, in some embodiments, to display only the relevant information for the specific asset.

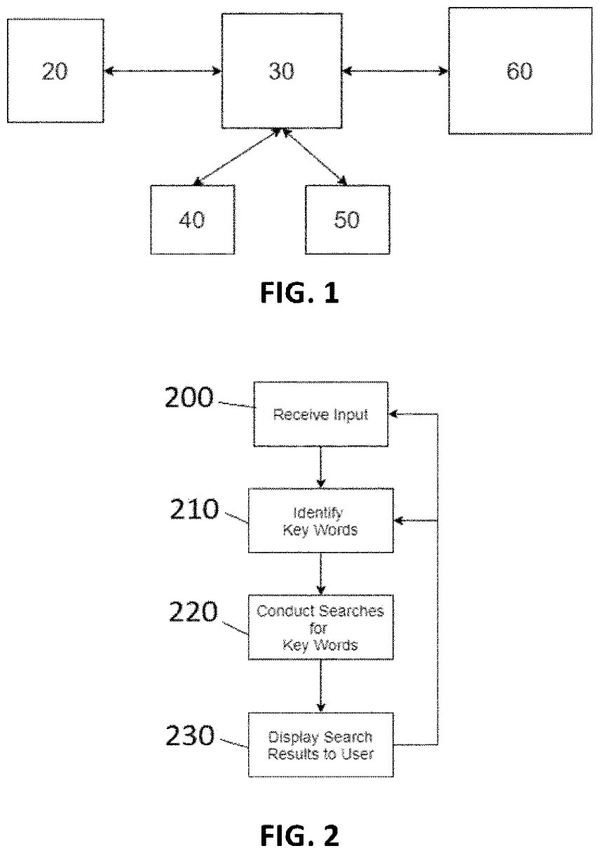

FIG. 1 shows a block diagram of the system 10 according to one embodiment of the invention. System 10 comprises a user interface 20 in communication with a processor 30. The processor 30 comprises at least an ideation module 40 and a documentation analysis module 50. The processor 30 is in communication with a database 60, which stores input received by the user interface 20 as well as information processed by the processor 30, and which may store other related information as necessary. The input can include, without limitation, transaction documents and data files related to an idea or an ideation process.

In one implementation, the system uses a software agent that is deployed in one or more computer systems in the organization. In a preferable implementation, these agents can be called up/executed by every employee or contractor of the organization (i.e., a user) based on permissions and the type of access given to each employee or contractor or director or related party to the organization. In some embodiments of the invention, user permissions for the execution of specific agents may be restricted to a smaller group of people, or a single individual, depending on the organization's structure. This may be preferable for some organizations.

Once the software agent is called up, the user can enter ideas, concepts, designs, and other matters that may generate IP. These may be entered as direct text input and/or by uploading data files that can be processed by the system. These data files may include, without limitation, numeric data, text files, image files, video files, audio files, unidimensional data, and/or multi-dimensional data.

For ideas that may generate patentable inventions, the system accepts invention disclosures, from every employee, contractor, or other user, through a quick guided series of directed questions and answers. Again, to avoid the bottleneck of a single individual or team handling all such disclosures, every employee or other user may be provided the permission to upload such invention disclosures.

Depending on the configuration and on user initiated action, the system performs automated prior art searches (for patents and designs) and trademark registrability searches based on the keywords entered by the user. These keywords are provided to the ideation module 40 by way of direct entry by the user, or by user-added flags on specific keywords or by user designated keywords. Alternatively, in some implementations, the ideation module 40 identifies these keywords automatically from an analysis of user uploaded documentation. For instance, an AI model may be trained to identify the most significant words in a data file of a certain format or relating to a certain subject. Such an automated approach allows prior art searches to be initiated with minimal intervention from the user. Note, however, that the use of user entered keywords can also initiate prior art searches that proceed in the background. As the user enters keywords or as invention details are entered and keywords are identified, prior art searching can begin in the background. These user-initiated searchers may be stored in the system automatically or through a user-generated storage request.

In some embodiments, these prior art or trademark searches are performed by automated/robotic agents that perform searches of the Internet (e.g., via Google™) and/or that search publicly available intellectual property databases provided by various national, regional, and/or international intellectual property offices. Additionally, in some embodiments, the user can specify which databases they wish to search. Further, in some embodiments, the system may provide a static link to such databases to thereby allow the user to perform searches manually. Additionally, in certain embodiments, searching may be carried out in the organization's internal databases and/or records storage using plug-ins and/or agents.

The user interface 20 also allows for the real-time entry and updating of keywords, based on the entry of ideas, notes, and data files from the user. As these ideas and notes are entered, the system automatically searches prior art based on the ideas and notes entered and the results of these searches are provided to the user as soon as matching references are found. Accordingly, updated search results may be provided almost instantaneously, depending on the factors surrounding the prior art searches. Accordingly, as ideation progresses, the prior art or trademarks found from the searches may change on the fly, thereby presenting relevant and/or valuable references that saves the user valuable time.

As another aspect of the present invention, the system accepts, for loading into its database, product images or images of products produced and/or marketed and/or sold by the organization. For products that cannot be imaged or pictured, or for products that can be protected by other forms of protection other than patents or trademarks, the system may be configured to suggest such other forms of registration. For instance, the system 10 may recommend that the user consider seeking design registration or other forms of IP rights (e.g., plant breeder rights for a cannabis business). The system may also suggest or recommend other forms of IP such as utility models in certain jurisdictions, and/or integrated circuit topography protection in others.

In other embodiments, the system is configured to produce black and white drawings from sketches and images entered by the user through the user interface 20. That is, in these embodiments, the processor 30 accesses or links to an image-conversion module that allows user provided images to be converted into line drawings suitable for filing. The use of such a module allows for the quick production of designs and concepts that can be sent to IP professionals for their use such as, for example, in the preparation of suitable patent/design applications. Additionally, as should be understood, in embodiments where the system 10 is a multi-tenant system, IP professionals and/or other expert users are provided direct access to the system 10. This allows such users to review drawings and other documents themselves. Such multi-tenant embodiments of the present invention will be discussed in more detail below.

For transaction data files (i.e., data files that contain documents related to transactions such as contracts and other agreements), the system accepts user entered electronic copies of these data files. Such electronic copies are then added to the system's database 60. As examples, the system accepts all transaction data files (e.g., employment, software license, sales or channel agreements) relating to a transaction from a user. These data files are then stored into the database and are associated with the relevant IP matters and IP assets. The images of the agreements are then converted by the system into computer-readable text by applying, for example, optical character recognition processes. Machine learning and/or artificial intelligence-based methods and subsystems are then applied to the resulting computer-readable text to thereby analyze the agreements. These methods and subsystems may include techniques related to natural language processing (NLP) and artificial intelligence models trained on suitable and relevant documents. It should be clear that optical character recognition may not be required as a separate step: for instance, contracts may be entered as text files that do not require special conversion. Alternatively, depending on the system configuration, some artificial intelligence models may be able to combine character-recognition tasks and semantic parsing tasks, rather than requiring separate processes.

Once the relevant documents have been entered into the system and have been suitably ingested, the documentation analysis module 50 can flag IP risks and related legal risks based on the results of the analysis. The results and potential risks of these analyses can then be provided to the user using the user interface 20. As noted above, it should be clear that legal advice is never provided by the system. The system merely analyzes documentation and, based on the analysis, the system flags potential risks based on predetermined risk categories and provides relevant examples of such risks. The system may also alert the user that legal advice from a legal expert in the appropriate jurisdiction should be obtained depending on the analysis results. To this end, the user interface 20 may display warnings that indicate what legal advice may be required (e.g., what legal field or expertise may be required). The system may also show the user sample clauses, agreements, and other documentation (with suitable predetermined explanations) to highlight the potential risks found in the user's documentation. Such examples may assist the user in understanding what has been flagged in the documentation. The potential risks in the documentation may be flags presented as, e.g., pop-ups, bubbles, notifications, or other warnings. Additionally, the flags may be output into a single file for printing or sharing by the user.

In one embodiment, the documentation analysis module 50 analyzes the inputted data files against a plurality of key root words stored in the database 60. As should be understood, the key root words are words associated with transaction language and/or with transaction risks. The plurality of key root words may be updated by a subject matter expert on a regular basis and/or may be updated and developed by a trained AI model. The AI model may be continuously updated/trained using a suitable feedback loop with a subject matter expert. As non-limiting examples, the key root words may include terms such as “warrant*” and “indemnif*” (wherein the asterisk is a wild-card, representing any possible character). Key root words can, of course, be full words that do not include wild-card symbols.

In another aspect, the documentation analysis module 50 may be used to identify a presence or an absence of at least one transaction term in an analyzed data file. For clarity, the at least one transaction term may be a term that matches a term derived from at least one key root word in the plurality of key root words. For instance, using the examples above, a transaction term may include “warranty” or “indemnification”. Once the presence (or absence) of a transaction term has been determined, the documentation analysis module 50 may provide the user, using the user interface 20, with preferred documentation language related to that transaction term. As an example, the user interface 20 can be used to provide the user with a preferred definition of “Invention”.

It should be clear that a database of preferred documentation language may be created with the assistance of suitable legal experts. Such preferred documentation language in the database would, preferably, accord with suitable laws, regulations, case law, and best practices, and may be influenced by the organization's goals. The database of preferred documentation language can provide the user with specific language for use in documentation such as contracts and agreements. Variants of such preferred language may be provided to the user using the user interface and, preferably, the user interface provides the user with an easy-to-use interface to choose their preferred phraseology for specific documents. Preferred documentation language can be stored in the database 60. In some cases, preferred documentation language may be based on the output of the ideation module 40, or the user input thereto. That is, in some embodiments, the system may retrieve suitable data from the ideation module 40 and from the documentation analysis module 50 and/or may use the data contained in each to create suitable recommendations to the user. For instance, the preferred documentation language for the description of a patented system that is to be licensed to a third party may be extracted from the original user entry entered during the ideation stage. Similarly, at the ideation stage, the ideation module 40 may flag potential issues with a potential invention that arises because of an agreement processed by the documentation analysis module 50. As should be clear, the systems may use both the ideation module 40 and the documentation analysis module 50, as well as the data generated from or entered into each, as a basis for making recommendations to the user. Of course, the system may retrieve, check, or otherwise consult data or entries associated with any of its modules to produce suitable recommendations to the user.

As one function of the system, the system may flag the presence or the absence of a specific transaction term. The AI model used in identifying transaction terms may be continuously trained on whatever agreements are entered into the system. As such, as more agreements are entered into the system, or as the rules or AI model of the documentation analysis module 50 change, certain standard terms that should be included in legal agreements may be identified or flagged as key root words that the system analyzes the documents for. For instance, most agreements related to IP assets should contain some mention of Confidential Information. Accordingly, the documentation analysis module 50 may be automatically directed to always look for the key root word “confidential*”, and to flag its absence to the user. This flag may be, e.g., a warning bubble or notification provided to the user by way of the user interface 20. The notification may note the absence of an important term and, in addition, the notification may also provide suggested preferred language.

In some embodiments, the system 10 also performs an analysis of changes in transaction documents over time. Additionally, the system may also perform an analysis of the differences between documentations for different transactions. In such embodiments, the user inputs at least a first transaction documentation file and a second transaction documentation file that is a subsequent version of the first transaction documentation file. The first transaction documentation file and the second transaction documentation file in this embodiment are both related to a first transaction. In some embodiments, the system 10 tracks new versions of documentation files based on the documents' contents, regardless of file name. In such embodiments, significant effort typically expended on file naming conventions can be saved. For clarity, the system may analyze different documents and, based on the similarity of such documents, the user may be prompted as to whether the different documents are related (i.e. are the documents different versions of a base document).

The documentation analysis module 50 can then identify differences in documentation language between the first transaction documentation file and the second transaction documentation file, again using rules- and/or AI-based techniques. As should be clear, AI and machine learning techniques such as NLP trained on legal documents are preferable to hard-coded rules, as such AI techniques allow the system to recognize slightly different phrases that have similar effects (and vice versa). That is, trained AI systems generally allow slightly more flexibility than rules based techniques.

The documentation analysis module 50 also flags the differences between the first transaction documentation file and the second transaction documentation file. In particular, in one implementation, the documentation analysis module 50 records/notes broad sections of the document that have changed, in addition to noting specific wording changes. For instance, indemnifications in a contract may pass through several rounds of changes. The documentation analysis module 50, if it detects such changes, could note this as a high-level change (either by referring to subject headings in the document or by analyzing the context of each change, depending on the specific implementation of the module 50). Such high-level changes could be stored as metadata on the transaction documentation files or could be recorded in an easily accessible ‘notes’ file related to the overall transaction itself and stored in the database 60.

For some implementations, specific documentation language that has been changed to result in documentation language in the second transaction documentation file may be flagged to become preferred documentation language for the associated key root word. This specific language may also be stored in the database 60 for later reuse in other documents or agreements.

As should be noted, the most recent version of a document may not be the most favourable for the organization. Accordingly, the system allows the user to flag language from the original version of the document to be preferred language. Additionally, alternate preferred documentation language may also be flagged by the user and stored in database 60 in association with a specific key root word or transaction term. In such embodiments, the system prompts the user to select between multiple alternatives for the preferred language. The user can then select the more suitable alternative, depending on the user's goal (e.g., depending whether they wish to compromise or to reject the other party's proposal).

It should be clear that multiple versions of a document may be entered into the system and changes between these versions may continually be noted by the system. For such eventualities, the system continuously updates the preferred language/phraseology used in the last version such that the most recent language amended by the user is continually flagged as being the preferred version. In a preferred implementation, the different versions and the different preferred language selections are used to train an AI model on preferred documentation language through changes made to documentation transaction files. The resulting AI model can then be used to anticipate language or to recommend language that the user will prefer, rather than requiring the user to select alternative language.

In addition to the above and as previously mentioned, the system also allows users to enter trademarks, brands, slogans, and designs into the database, through the ideation module or through other modules. The entered trademarks, brands, slogans, logos, and designs can then be used by the system to perform automated trademark searches. Depending on the results of the automated trademark searches, the system flags potential issues with established or registered brands. In one implementation, the automated trademark searches are handled by the ideation module 20 or, in some implementations, by separate trademarks and/or design ideation modules. In addition, the system allows for dates of first use for various marks/designs to be entered into the system. These dates are then tracked by the system. Additionally, the system may provide the user with images or examples of how to mark products, with the images or examples being provided through the user interface 20.

One implementation of the present invention uses a smart database with built-in logic-based rules that determine generated outputs based on the provided inputs. Note, however, that, in some instances, such a rules-based system may struggle to provide sufficient flexibility as laws, practices, and the organization's goals and assets evolve. It should, however, be clear that a system that is at least partially based on machine learning and artificial intelligence techniques and modules is generally preferable.

For some implementations, a system configured to use machine learning and artificial intelligence to learn from training data sets may be used to encapsulate relevant legal and patent advice in order to reduce risks. For example, suitable AI models may be used by the documentation analysis module 50 to identify more and more issues in contract reviews by continuously learning with the use of suitable feedback loops. In some implementations, the material provided by a user as invention disclosures can be adjusted by the ideation module 40 using predetermined patent application templates. The adjusted documentation is, preferably, more useful to IP professionals when it comes to preparing IP filings (such as patent application filings). The system can be configured to learn, from patent applications in the same field, how to transform a user's ideas into a product that is more useful for patent professionals. Thus, by feeding the stored documentation back into a learning AI model, as a patent portfolio increases in size, the system learns more and becomes better and more capable at converting a user's ideas into a product more usable by patent professionals. Preferably, this will reduce costs for the organization and, also preferably, reduces the time required to file a new patent application. The system can also provide similar advantages on the agreements side as stored agreements are used to train suitable AI models. As a company or organization enters more agreements into the database and as these agreements are used to train the relevant AI models, and as the organization signs more patent licensing or sales agreements, the system AI modules learn to flag issues such that less user intervention is required when the system reviews agreements.

It should be clear that the database of the system may be implemented with a built-in expert system that takes into account the law in various jurisdictions. Such an expert system allows for the analysis of agreements using, as governing law, the law in various jurisdictions. Again, this expert system may be completely or partially rules-based. However, the expert system is preferably used in conjunction with machine learning and artificial intelligence agents, and/or is at least partially based on machine learning and artificial intelligence techniques, to more effectively flag possible issues in different jurisdictions. The expert system may be configured/created using input from experts (e.g., lawyers, patent agents, trademark agents, etc.) in the relevant fields of law (e.g., IP, contracts, employment law) in various jurisdictions. The expert system may be constructed such that the logic/expertise used by the expert system to assess the organization's agreements in the database is based on the advice and expertise of the above noted experts. Such logic/expertise may be provided as rules to be directly implemented, or as data to be used in a training process in order to train an AI-based module to evaluate such agreements. Thus, in the example, the system may be suitable for analyzing agreements for possible issues relating to the relevant laws and rules in Delaware, New York, California, Illinois, Ontario, Quebec, BC, Florida, UK, etc.

As should be clear from the above, a system using such AI approaches is able to tailor its recommendations to the goals and purposes of the organization. Such recommendations can take into account changes in relevant laws, regulations, and best practices. However, it should be clear that the system does not provide legal advice. Recommendations are provided based on best practices and regulations as well as on prevailing law.

In some implementations, the system 10 also provides links and/or contact information that allows users to contact IP experts, such as patent/trademark agents and/or IP lawyers or other legal and related advisors. This information may include, e.g., expedited email forms, phone numbers, and/or chat windows. Additionally, the user interface 20 may provide links to databases or webpages listing such experts.

For other implementations, the system 10 also provides basic informational resources stored in the database 60 and accessible through the user interface 20. These may include Frequently Asked Questions documents, copies of legal notices, and other relevant information.

Other implementations also provide a system 10 that includes a notepad with suitable notepad functions. The notepad functions can be implemented by way of a notepad module that is accessible through the user interface 20. The notepad module, when activated, provides the user with a blank workspace where the user can add text, graphics or drawings, as well as links to various websites. In some embodiments, the user can also drag and drop video and/or audio into the notepad. The notepad module may also provide formatting functions.

Additionally, in some embodiments, the system 10 includes a budgeting module or widget that allows the user to forecast how much certain IP protection strategies cost. The budgeting module would retrieve relevant cost information from the database based on user queries. As an example, a user may want to know how much a National Phase Entry application would cost in Canada. The budgeting module would retrieve data relating to official filing fees as well as a range of firm fees from the database. Costs for potential ancillary fees may also be retrieved from the database. These estimates and costs are then aggregated and provided to the user in a suitable format.

In one implementation, the system and its related database may be hosted at the organization's premises/servers, or the system and its database may be hosted at a server located at a location or locations remote from the organization. Alternatively, the system may be hosted in a cloud-based server and users/organizations can access the system using a software-as-a-service (SaaS) subscription-based model. Different constraints and/or user requirements may determine how the system is provided: for instance, an organization with significant in-house processing power may prefer a locally hosted version of the system.

The system services may also be accessed by users using multiple forms of computer or data processing devices. As examples, suitable apps or agents for accessing the system may be provided on the user's mobile or desktop devices. Such desktop and mobile applications can be used to ensure that content by users can be easily uploaded. Other forms of access may be provided, depending on the available technology.

Similarly, it should be clear that the database(s) provided by this system may store data in any suitable fashion. For instance, the data may be stored directly on-site, in the cloud, or on a server remote from the organization. Further, in some embodiments, plug-ins or interface agents may allow the system to access data in the organization's pre-existing or in third-party databases. In some implementations, the access to such databases negates the need for the user to directly enter specific information to the system. Rather, the system, for these implementations, automatically scans or processes any documents in the organization's database to flag potential issues. Additionally, as should be clear, any document, file, or other data stored in the database 60 is available to any module of the system 10 for any suitable purpose, e.g., any such document may be used by the ideation module when searching. For clarity, the organization of the data stored by the system and its database may be implemented by way of a management module. Such a management module can ensure that data files, documentation, and assorted data associated with a specific IP asset is tagged and/or organized as being associated/stored under that specific IP asset's identifier. The management module ensures that each data object (whether that data object is a data file, a piece of data, a digital document, a note, etc.) is associated with at least one specific IP asset being tracked. This ensures that each data object is properly identified and identifiable by its associated IP asset.

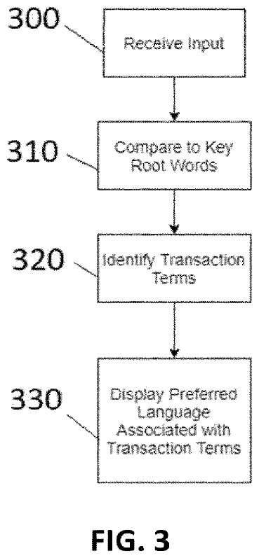

FIG. 2 is a flowchart detailing a method according to an aspect of the invention. Specifically, FIG. 2 details a method when input relating to an idea is received (step 200). Keywords are identified at step 210, either directly by the user or by the ideation module of the system. Searches based on those keywords are then performed at step 220. The results of the searches are displayed to the user at step 230. As should be clear, searching is an iterative process and the user may choose to add additional information or identify new key words after viewing the results, thus returning to an earlier step.

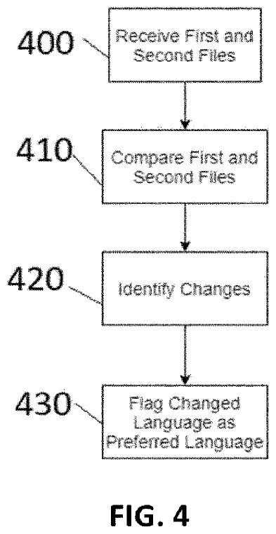

FIG. 3 is another flowchart detailing a method according to the present invention. Specifically, FIG. 3 details a method when a transaction document, such as a contract, is received (step 300). At step 310, the document is analyzed and compared to a plurality of key root words. Transaction term(s) related to key root word(s) within that document are identified at step 320. Then, at step 330, preferred language associated with the transaction term(s) and/or the key root word(s) is displayed to the user through the user interface.

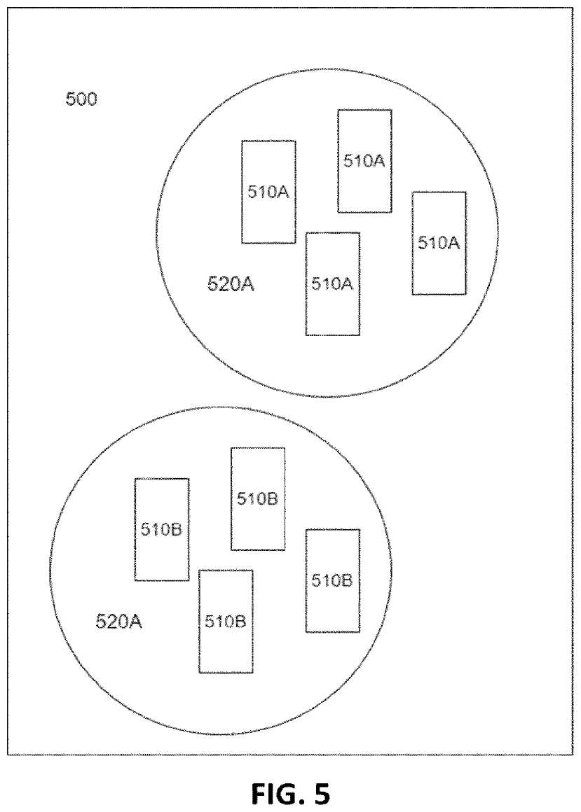

FIG. 4 is another flowchart detailing a method according to the present invention. Specifically, FIG. 4 details a method when two versions of a transaction document, such as a contract, are received (step 400). At step 410, the first and second versions of the files are compared to each other, and changes related to transaction terms and/or key root words are identified at step 420. The changed language (i.e., the language in the second version of the file) is flagged as preferred language at step 430. That language may then be displayed to a user.

As should be clear, the single system of the present invention is capable of performing each of these methods. Further, a server unit 70 can comprise each of the above-identified modules, as well as other modules.

Additionally, as should be clear, some embodiments of the system (for instance, embodiments hosted on the cloud or permitting multiple simultaneous users) may support many simultaneous classes of user. In general, these can comprise “organization users”, “expert users”, and “third-party users”. For clarity, third-party users are users without direct connections to the organization and its users.

Organization users are users who represent organizations that store their own ideas, concepts, asset documentation, transaction documentation, etc. on the system. As would be understood, of course, a record of the organization and of any associated organizations users may also be retained on the system, in the database. Organization users can include sole inventors, administrative personnel, engineers and technical personnel, officers, directors, sales and marketing personnel, and other representatives of an organization's interests, or outside contractors or consultants. An “organization” can comprise one or more people. In addition, there may be cases in which it would not be preferable for every organization user to have the same access to all data files on the system. For instance, if an organization uses the system for managing trademark information and/or assets and also uses the system for managing legal agreements related to those trademarks, certain representatives of the organization, such as graphics designers, may not need to have access to both kinds of data. Accordingly, in some embodiments, an organization has at least one “controlling user” (e.g. a system administrator) who is able to designate other users who should have the ability to access and/or modify specific documents/assets/data files that the organization stores on the system, for instance by assigning read/write permissions.

Expert users are experts such as IP professionals, lawyers and legal advisors, and technical experts who may be asked by the organization user(s) to review and/or manage and/or consult on specific projects. Expert users may also store data files (for instance, templates) on the system. When an organization establishes a relationship with an expert user (e.g., when a company becomes a client of a lawyer, or when an agency relationship is established between the parties for the purposes of a certain IP asset, or when collaborations occur such as partnerships and joint ventures or licensees are established, or due diligence is conducted that requires permitted access), the organization's controlling user(s) would grant the appropriate expert user(s) permissions to access and/or modify to the organization's data files. In some embodiments, the expert user's data files may be shared with the organization directly on the system (i.e., the expert user could grant access to the organization user(s) to use the expert user's templates, etc.). Of course, the controlling user(s) could also revoke such permissions, for instance if the relationship between the parties is severed outside of the system, or if a certain matter changes hands.

Additionally, other types of users are contemplated. For example, other advisors to the organizations, investors or funders of the organizations, or its customers may be users and form user groups with different read/write permissions and access.

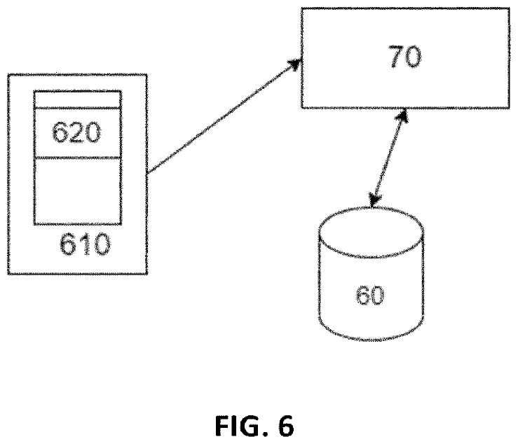

The data files uploaded are preferably organized in a logical structure that groups together related data files and documentation. As noted above, data files and documentation are organized/associated with at least one IP asset that the data file/documentation relates to. It should be clear that data files are organized automatically by the system in terms of IP assets but that users may also impose their own organizational structure. FIG. 5 is a schematic diagram showing such a logical structure. An organization 500 can manage one or more associated “projects”. Projects, as used herein, include any product, service, asset, idea, transaction or other work of the organization. A project may be any size and of any significance and may be associated with an unlimited number of data files 510. For instance, a flagship product offered by an organization could be associated with several different IP assets, transaction data files, and so on. Each project is thus represented by a “project object” 520, which is formed by linking together each relevant data file 510 uploaded to the system. Thus, in FIG. 5, each data file 510A relates to a certain project and are linked together as a “project object” 520A. The data files 510B, likewise, are linked together in a project object 520B and are related to a different project. Further, each data file 510 may be linked to/associated with more than one project object (e.g, a transaction may relate to more than one project, and thus would be linked to each relevant project object). Thus, a data object may be associated, in a first instance, with a specific IP asset. However, that same data object may also be tagged/linked with a specific project/project object. Similarly, an IP asset may be tagged/associated with a specific project and, in one implementation; all data objects under that IP asset are also tagged with that specific project.

It should also be noted that a project object can be associated with more than one organization or derive from another organization, in an IP licensee situation or based on a transaction, for example. As well, a single IP asset may belong to multiple project objects, including project objects maintained by different organizations.

Project objects can be created by a user to represent any desired grouping of information, data files, IP assets, workflow, etc. For example, a project object may be related to a single inventive concept on which numerous related patent families are based. Such a project object could include the related patent families, contracts such as non-disclosure agreements, licensing agreements, etc., and other related documents and/or IP assets. As another non-limiting example, a project object may relate to a corporate project that involves multiple teams and/or IP assets.

As well, a project object can comprise workflows and predetermined processes related to the specific project. That is, a project object can be more than a simple static linking of documents within a storage space and can incorporate rules governing the various relationships between linked assets, users, projects, etc.

The person skilled in the art would be aware of many possible linking methods, including the use of a key or other identifying parameter that references the specific project object 520A, or the creation of a branching data structure for each project object. As would be understood, data files 510 may be uploaded separately and/or in batches. Further, of course, each data file 510 can be any form of data file, including common text, spreadsheet, and/or image file formats, as well as project-specific files, creative files, audio and/or video data, and multi-dimensional data files.

For clarity, the tagging/associating of data objects, IP assets, data files, documentation with specific projects/project objects is implemented by the management module. Of course, as projects and project objects are user defined, the management module only tags/associates specific data objects with a specific project if a suitable user has designated those specific data objects to be with that specific project.

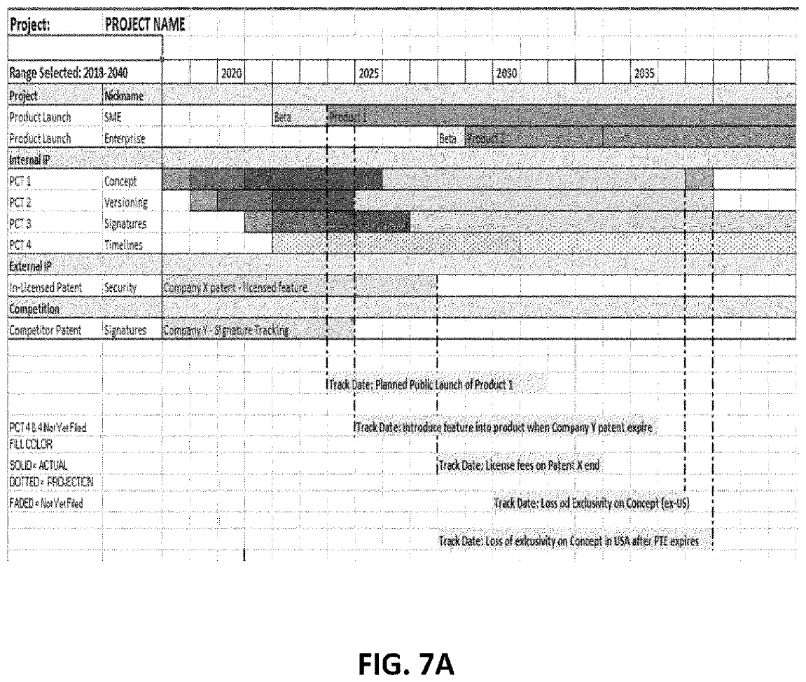

Data files may also be directly uploaded to the system by a user through a third-party application. That is, in some embodiments, the user interface 20 can integrate with a third-party application on a computing device used by a user, such as a mobile phone. Such third-party applications may include, e.g., email clients, messenger services, etc. Such an embodiment is shown in FIG. 6. The system can accept a user upload that has been uploaded using a third-party application on a personal computing device 610, with the data file being directly uploaded to the server 70 from the third-party application, by way of the integrated user interface feature 620. The server 70 can then store the data file in the database 60. Additionally, in some embodiments, the user 600 can designate at least one relevant project object for the data file before uploading the data file to the server. In other embodiments, however, particularly embodiments with machine learning/natural-language-processing and/or classifying capabilities, the server 70 can determine at least one relevant project object without user direction, assuming that the at least one relevant project object has already been previously defined/created.

Additionally, in some embodiments, each project has its own controlling user who is responsible for designating others who may access the data objects associated with the project, including data files. In some cases, these designations could be different for each other user and/or each file comprising the project object, while in other cases certain users who are not the controlling user may still have access and/or modification rights for all data files related to the project and to the project itself. For instance, the president of an organization may have access and/or modification permissions to all files associated with all projects, while administrative personnel may only be able to view specific files in specific projects.

In some embodiments, each project object has default security settings that apply to all users who can access the project object. That is, all users connected to a project object can see all related content of the project object. In other embodiments, a project object can support multiple security/permissions settings. Further, in some embodiments, a project object inherits the security/permissions settings of its content. As an example, a patent document A and a budget projection document B may be uploaded to the system. A user account of a listed inventor on patent document A may have access to the patent document A but not to the budget document B. Conversely, a user account of a company executive may have access to both the patent document A and the budget document B. If the patent document A and the budget document B are linked together in a project object, in an embodiment of the system in which security settings are inherited, the listed inventor would have access to the project object and the patent document A, but still not have access to the budget document B. The executive, similarly, would have access to the project object, the patent document A, and the budget document B.

### Reports and Visualizations

In some embodiments, the user(s) can generate tracking reports for each project object and/or for specific IP assets, including families of patents, designs and trademarks. For example, a tracking report can be generated for a project object that includes all trademark files owned by a specific corporate entity. Such a report can comprise, for example: details of the trademarks; relevant dates for each trademark (such as, without limitation, upcoming renewal dates); associated fees; fees and expenses to date; and any other relevant parameter. As would be clear, the information in such a report can depend on the specific project object and/or IP asset(s) that is/are the subject of the report. In some embodiments, the tracking report is user-customizable (i.e., the user generating the report can select data that they wish to see in the report). Similarly, reports can be generated at a high level or with greater specificity.

As would be clear, such reports can be generated in any suitable format. In some embodiments, reports are directly generated within the user interface. Alternatively or additionally, reports are exportable outside of the user interface of the system, using third-party or proprietary software applications, such as spreadsheet programs and/or word-processing programs. In some embodiments, the format of the reports is user-selectable. The reports can also be shared with other users of the system, depending on security permissions.

In one embodiment, project objects and tracking reports can also be used to automate specific functions. As one example, the organization operating the system may be a law firm or a patent or trademark agency firm that represents clients. For such an implementation, the users of the system 10 would be the employees of the firm and/or agency. For such an implementation, a specific project object may be configured to correspond to a specific client. When the system users upload specific documents, specific pre-determined types of reports may be automatically generated. The users can then review the reports and modify as necessary. Alternatively, or additionally, reminders can also be automatically delivered to users through messaging means (such as through email or short messaging such as through cellular texting) in advance of specific deadlines. To facilitate such embodiments, the system 10 can further comprise a docketing module for determining relevant dates, such as deadlines and reminder dates. The system 10 can also include a content generation module for automatically generating predetermined reports, communications, etc. based on the relevant dates and on predetermined templates. As would be understood, the relevant dates can depend on the type of IP asset(s) in the project object, as well as the jurisdictions/countries associated with the IP asset(s) and specific circumstances of the IP asset(s), as applicable.

It should be clear that, in implementations configured for a law firm and/or IP agency, since each client's matters are associated with a single project object, the workflows/predetermined rules within that project object can include how to handle the reporting of IP applications (including which email addresses to send reporting packages to), how to bill matters (e.g., invoicing or billing preferences of this particular client), which email addresses to use for which matters, and which email addresses to use for documents such as invoices. The system can thus automatically generate suitable form letters for reporting events related to IP matters handled by the firm, with the form letters being generated from suitable templates that have been filled out with data from the IP matter being reported on. Thus, reporting an incoming Office Action for a trademark or a patent matter would simply be a matter of the system retrieving the relevant template, inserting the so-called tombstone information for the IP matter into the template (i.e., the application number, title, filing date, any priority dates, publication date, etc.), and attaching a copy of the Office Action to the resulting reporting letter. The reporting letter and the copy of the Office Action can then be automatically packaged and sent to the relevant email addresses based on the workflow designated in the project for that client. Of course, the actual Office Action document may need to be entered into the system by a user and the data for that Office Action may need to be manually entered. However, suitable document recognition software and suitable OCR software can be used to automate the document entry process as needed, as also described above. It should also be clear the that so-called tombstone information may be stored in the system database for easy retrieval. The tombstone information may be entered into the database when the matter/file is opened/created.

Additionally, in some embodiments, the user interface may display a visual representation of the data files comprising each project object (e.g, a ‘mind map’, graph, chart or other diagram showing the relationships between the data files comprising a project object). Such a visual representation/visualization can provide a way to see the relationships between various IP assets.

In some embodiments, project objects can be represented as an interactive visualization. Such interactive visualizations may be particularly useful with more complex/hierarchical project objects (e.g., project objects that link together other project objects), but can also be suitable for simpler project objects, as may be determined by the user.

In some embodiments, a timeline visualization for a project object and/or an IP asset can also be generated. That is, a report that contains a visual representation of dates of important and/or relevant events, including past dates and/or projections, can be presented to a user. The timeline may be a simple line with relevant dates marked on the line, or may be more complex. For example, the timeline may show events related to several different IP assets, including regulatory deadlines, process deadlines, internal deadlines, etc. Further, important ‘crossover points’ can be highlighted on the visualization (e.g., where two periods intersect in some meaningful way). As would be understood, what qualifies as ‘meaningful’ depends on the IP assets in question and the specific circumstances of any particular project.

In some implementations, colour coding and/or specific blocks may be used to represent differences between periods of time. For example, if the timeline shows the patenting process for a specific invention, different coloured blocks can be used to display periods of time when a reference is citable against a patent application for that specific invention and when the reference would not be citable.

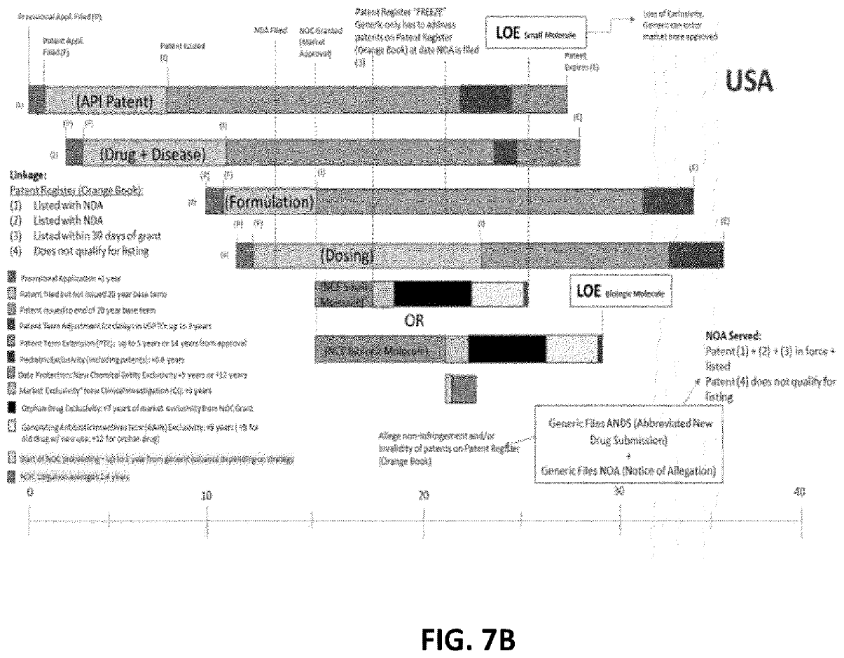

Exemplary timeline visualizations are shown in FIGS. 7A, 7B, and 7C. Each of these figures shows a timeline visualization representing multiple products, IP assets, and/or corporate projects. As would be understood, a timeline visualization can be generated for or from any tracking report, IP asset, or project object, provided there are at least two relevant dates that can be placed on a visualized timeline. Further, the timeline visualizations can contain information related to regulatory regimes and regulatory periods, competitor assets (e.g., competitors' patents), business information including financial information, contracts, corporate projects, etc., and any other relevant data. Such information can, in some implementations, be layered over a base visualization. That is, the generated visualization in some embodiments may have a number of selectable layers, each layer representing different information. Preferably each layer's visibility on the base timeline can be toggled by a user as desired.

For some embodiments of the generated timeline, each period of time can be manually determined by a user or the period of time can be automatically generated by the system. As one example, a contract might have an effective date of Jan. 1, 2022, and a term of three years. In some embodiments, a user would enter that the last day of the contract's effective period is Dec. 31, 2025. In other embodiments, the system extracts the effective date and the term length from the uploaded contract and calculates the effective period based on the extracted effective date and the term length. In some embodiments, calculation rules for various common periods in different jurisdictions are pre-determined and provided to the docketing module such that the docketing module automatically generates the relevant deadlines, reminders, and timelines as may be needed by a user. For example, many countries and jurisdictions have different publication periods for trademark applications before registration (e.g., two months, three months, etc.). The different timelines and deadlines associated with these timelines and periods can be automatically generated by the docketing module based on the jurisdiction based calculation rules. In some embodiments, the docketing module can be preloaded with calculation rules to determine the appropriate publication period for the visualization based on the relevant jurisdiction and the publication date.

As can be imagined, the timeline visualization can include milestones that are related to IP assets or IP asset related rights. As such, milestones illustrated/represented on the timeline visualization can relate to any of government regulations; an IP asset related deadline; a filing date; a priority date; a date of publication; a product launch date; a grant date; an approval date; an implementation date; an expiry of IP related rights; an expiry of license rights; and an expiry of exclusivity rights. As one specific example, the date of expiry of an IP related license or the expiry of licensed IP rights may be tracked by the docketing module and suitable reminders may be automatically generated and sent to relevant users of the system. The reminders may remind users of the need to renew/renegotiate the IP license that is set to expire. This function may be implemented by using a combination of the docketing module, the database module (for storing the data), the documentation analysis module (to extract the relevant dates), and the timeline visualization module (to visually alert the user of the deadlines).

In some embodiments, the visible indicia viewed by a user as a timeline visualization is automatically generated based on data extracted from documents uploaded to the system by the user. Certain periods and/or certain dates may be automatically generated (as a non-limiting example, a base patent term may be automatically generated based on dates extracted from a published issued patent document). Further, in some embodiments, data can be extracted from other sources, such as proprietary external systems, patent office records, etc. The data can be automatically extracted from such external records once suitable identification of the related IP asset has been entered by the user into the system. The system can then automatically access online accessible databases to retrieve the relevant data based on the identification of the related IP asset (e.g. a patent application or an issued patent, with either being identified by the user with a publication number).

Alternatively or additionally, the timeline visualization can be automatically generated based on user entered customizations. That is, in some embodiments, the user can directly enter the length of a specific period of interest to be displayed as part of the timeline visualization. Further, in some embodiments, the system accepts user input that can be displayed on the timeline as notes/comments. The user entered notes/comments are displayed at specific points in the timeline to mark points of particular interest within the timeline. In some embodiments, these user entered notes/comments can be exported and/or accessed outside of the system. Further, in other embodiments, the user entered notes/comments are associated with specific event dates in a system database and are re-used in other visualizations, as detailed and configured by the user. Additionally, in some embodiments, the user entered notes/comments can be shared with other users, depending on security permissions.

In some embodiments, the timeline visualizations are interactive as opposed to being simply static timelines. In one embodiment, for example, if a user hovers the cursor over a specific point on a timeline visualization, or selects a specific point, this causes data associated with that specific point to be displayed. Such data can be a user-entered notes/comment as described above. The data to be displayed can also comprise information not directly entered as a comment, such as relevant facts related to a particular period on the timeline. Such data can also include, without limitation, other text data; image data; audio, video, or audiovisual data; numerical data; and/or any other suitable data format. Data stored in the database and associated with the particular timeline/IP asset as well as the particular point in the timeline may be displayed when the user selects/indicates that specific point in the timeline visualization.

Additionally, in some embodiments, the parameters of the timeline visualization are user configurable/selectable. Timeline visualization parameters that are user selectable/configurable may include, without limitation: an overall date range for the timeline visualization; specific information to be included; specific region(s) of interest; and a display order of information and/or assets to be the subject of the timeline visualization. Additionally, other user selectable settings for the timeline visualization may include aesthetic settings (e.g., specific colours or colour schemes, fonts, etc.).

In other embodiments, further, the system can generate a timeline visualization ‘snapshot’ for a particular date of interest—this may be equivalent to a timeline visualization where the overall date range is only one day long.) Such a snapshot, generated upon user activation, can be useful in assessing the state of an IP portfolio on a certain day. Further, in some embodiments, the system can generate a timeline visualization snapshot based on user entered speculative data. The system would thus generate a visualization for a potential, ‘what if’ scenario. As would be clear, such a ‘what-if’ visualization may be based on a combination of speculative and non-speculative data (i.e., real data).

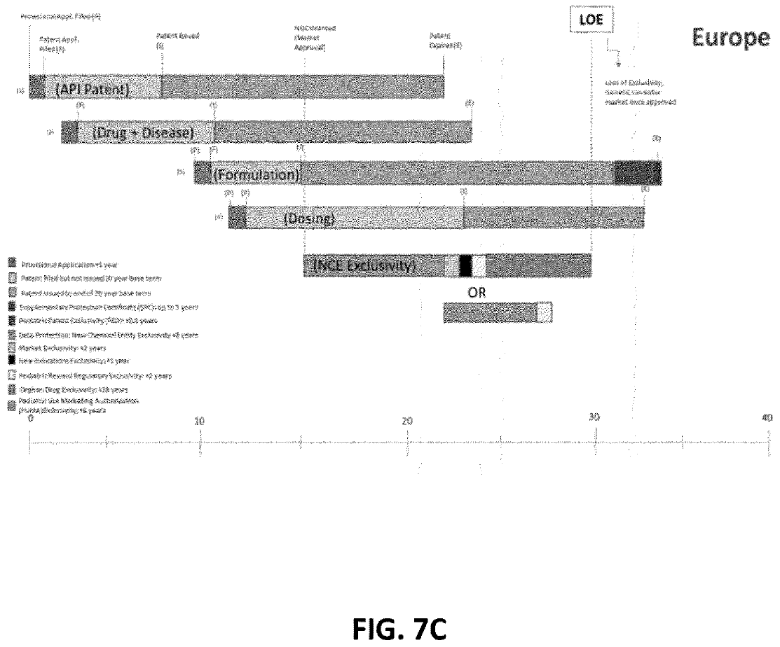

FIG. 8 is a block diagram of one embodiment of a system 810 for managing IP assets using such reports. A user interface 820 is used to upload documents/data/etc. to a server 830. The server 830 is in communication with a cloud-based data storage space for storing the received documents/data/etc. A reporting module 850 is also in communication with the server 830 or may be a part of the server 830. The reporting module can generate reports related to one or more uploaded documents, or to project objects related to the document(s), etc., as described above. The reports can then be presented to users via the user interface 820. As would also be clear, various other modules described herein can also be included in the system 810, depending on the embodiment. For example, in some embodiments, the system 810 can also comprises an ideation module 40 and a document analysis module 50, which function as described above. Alternatively or additionally, a docketing module could also be included in the system 810. The various modules detailed in FIG. 8 may be in communication with or be part of the server 830.

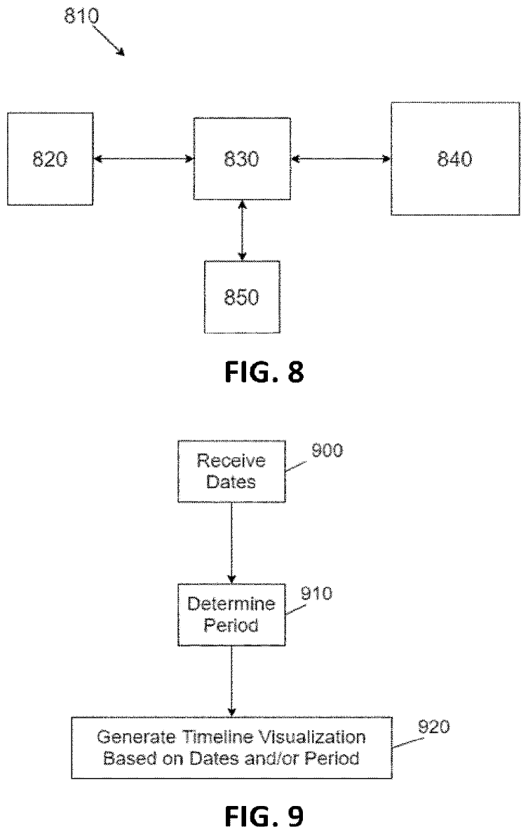

Referring now to FIG. 9, a flowchart detailing a method according to one aspect of the agreement is shown. At step 900, a plurality of dates is received. Each date is related to a milestone event associated with at least one project, IP asset, project object, etc. Fixed milestone dates may also be calculated based on the plurality of dates received and these fixed milestone dates can be incorporated into the plurality of dates. At step 910, at least one period is determined based on at least one pair of the plurality of dates. At step 920, a timeline visualization is generated. As described above, the timeline visualization is a visual representation of the at least one period and, in some embodiments, represents milestone dates for multiple assets/project objects/projects.

### Defects/Issues

It should be clear that some data files may contain defects and/or issues. Defects/issues include, without limitation, data or digital data problems with the file itself (e.g., glitches, corrupted text, etc.); problems with the content of the file, as determined by one or more users; and/or problems with the metadata associated with the file. For example, a data file containing a document relating to a transaction may lack proof of consent from all parties to the transaction. That is, the document may be unsigned by some or all of the parties. Such an issue may complicate the completion of a transaction by the parties. As another non-limiting example, specific data required to complete a transaction, such as an effective date, may be missing. Alternatively or additionally, the defect/issue can comprise document content that conflicts with or is incongruous with other document content and/or with the content of other documents. Defects/issues/problems in the metadata associated with a file could include, without limitation, an incorrect title or a missing title of the document, incorrect dates, incorrect or missing names of individuals or parties connected to the documents, etc. Further, in some cases, a defect/problem/issue may be related to a project object as a whole and/or the metadata of the project object, rather than to a specific single data file or document. As a non-limiting example, a defect or issue related to a project object could be that an incorrect user is linked to the project object, or that a certain IP asset that should be linked to the project object is not included. As can be imagined, a defect or issue may include missing or otherwise incomplete or incorrect data/indicia on a document that, ideally, should be present or correct on the document.

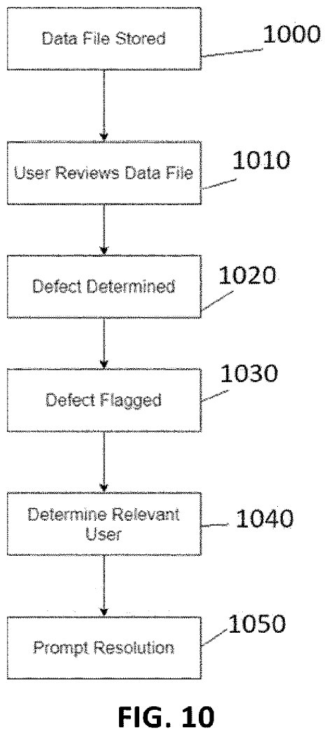

Defects/issues may also be identified in advance by users or by the system automatically or through completion of checklists. For example, checklists detailing necessary or required conditions (e.g. the presence of necessary signatures for specific documents) could be automatically completed as certain project objects or data files are created. As can be imagined, the system can automatically check the documentation/data files for the necessary or required conditions and, should these be present, the checklists can also be completed automatically. Incomplete checklists, with necessary or required conditions missing, can cause the automatic generation of notifications to specific users. Accordingly, one aspect of the system provides a system and method for resolving such defects/issues, as detailed in the flowchart of FIG. 10. At step 1000, a data file is stored on the system. At step 1010, a user reviews that data file. As may be understood, such review may be performed by expert users, for example, users who have expertise in the area of the data file and/or of the defect, and/or may be performed by any organization user. At step 1020, the user determines that a defect exists in the data file or in the content of the data file (e.g. missing signatures in an agreement). The defect is flagged at step 1030. Once the defect/issue has been flagged, an automatic notification may be generated. At step 1040, at least one relevant user (i.e., a user who can resolve or attempt to resolve the defect) is determined. At step 1050, the system notifies that relevant user about the defect and prompts that user to provide a resolution to the defect. For instance, in response to a defect being flagged, the system may auto-generate and auto-send an email to the relevant user(s), detailing the defect and suggesting an action that could resolve the defect. Further, in some embodiments using AI processes, the above-detailed method of defect review and flagging may be carried partially or fully autonomously by the system.

### Third Party Review

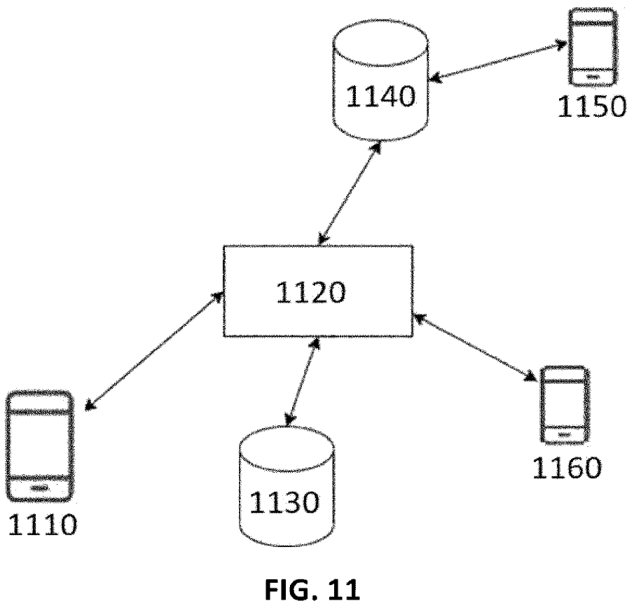

Referring now to FIG. 11, a block diagram illustrates a system according to another aspect of the invention. An organization user uploads data files to the server 1120, using the user interface on, and/or integrated with a third-party application on, a computing device 1110, as otherwise described herein. The data files are stored in a first database 1130. At various points, the organization user may wish to make certain projects, or parts of projects, or in some cases, the entire organization available for review by third party users. Accordingly (provided the relevant organization user has suitable permissions), the organization user can use the user interface to mark such projects/parts thereof/organizations as available for review. When such a designation is made, the server will add a reference to that project/part thereof/organization to a publicly visible second database 840, which can be accessed by third party users using computing devices 1150. In some cases, the third-party users can also provide feedback on the project/part thereof/organization. Additionally, as seen in FIG. 11, expert users using computing devices 1160 can also have access to the system, mediated by the server 1120 and depending on their assigned permissions. As would be clear, the computing devices 1110, 1150, and 1160 can be any device capable of communicating with the server 1120 and running the needed user interface(s), including, without limitation, devices such as smart phones, tablets, laptops, and desktop computers. As can be imagined, the system may provide such third-party users with suitable functionality to enable note making, marking, and/or editing of the data files as necessary and as desired. Of course, such suitable functionality can be curtailed/not be available based on the permissions provided to the third-party users.

It should be further noted that the first database 1130 may have a full or partial data room for IP due diligence, such that the database provides a list of assets for transactions including, but not limited to, licensing, acquisition, partnering, and funding. Additionally, the first database 1130 may be implemented as a cloud-based storage space or as an on-premise database.

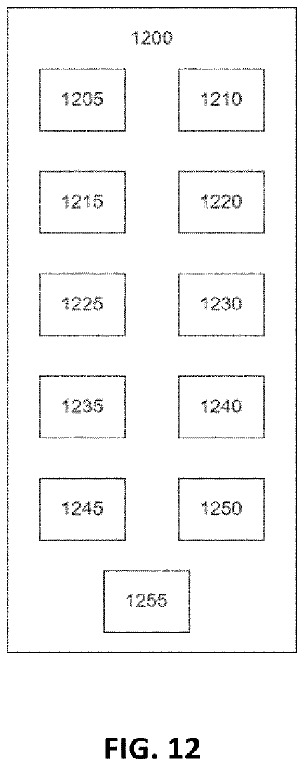

In another aspect, the system of the present invention may have a configuration as illustrated in FIG. 12. Referring to FIG. 12, the system 1200 includes a management module 1205, a user interface module 1210, and a database module 1215. In addition, the system may include a timeline reporting module 1220, a document analysis module 1225, an ideation module 1230, a docketing module 1235, an automated searching module 1240, a budgeting module 1245, a reporting module 1250, and a data extraction module 1255.

It should be clear that the management module 1205 provides management functions such as organizing data and data files and documentation uploaded to the system. The user interface module 1210 provides user interface services to the system and displays to the user the outputs of the various system modules while also receiving inputs from the user. Such inputs are, of course, routed to the relevant modules. The database module 1215 receives data, data files, and documentation from the user (by way of the user interface module) and stores such data, data files and documentation accordingly. The organization of the data stored in the database may be implementation dependent and may be imposed on the data by the management module. As can be imagined, the timeline reporting module generates timelines and timeline-based reports based on data retrieved from the database. The document analysis module provides functions as explained above. Similarly, the ideation module operates to assist users with capturing ideas and ensuring that potentially important ideas are documented and captured as necessary. The docketing module retrieves data from the database and tracks dates, milestones, and deadlines for IP assets. Reports, reminders, and other similar date related outputs are generated and presented to the user by the docketing module. The automated searching module interfaces with online IP databases and provides automated searching for relevant patent and trademark documentation based on user inputs. The results of the automated search are, of course, provided to the user by way of the user interface module. The budgeting module retrieves pricing data and official fees data from the database and, when queried by the user, provides cost estimates for specific IP related actions for various jurisdictions. Depending on the configuration of the budgeting module, budget-based what-if scenarios may be played out by the user using the budgeting module. The reporting module allows users to customize and create bespoke reports on the IP assets being tracked by the system. As well, the reporting module allows users to configure regular system generated reports to ensure that the reports provide the necessary data points retrieved from the database. The data extraction module, depending on the implementation, analyzes user provided documentation and extracts relevant data from such documentation. As well, the data extraction module may be configured to interface with specific online IP databases to scrape relevant data relating to the IP assets being tracked by the system. As such, as an example, if the system is tracking a specific US patent application, the data extraction module may interface with the USPTO public facing website, perform an automated query regarding the specific US patent application, and scrape the resulting automated USPTO response for the relevant data. This data can then be stored in the database for the specific IP asset.

It should be clear that, in one implementation, the database is implemented as a large data pool that stores the relevant data, data files, and documentation. Data, data files, and documentation can thus be retrieved and/or stored as needed in the database. The management module is used to impose an organizational structure over the data pool. The organizational structure may be automated and predefined for some aspects (e.g. associating specific data and documents with the IP asset that the data and the documents relate to). However, the organizational structure may also be user selected for other aspects (e.g. organizing specific data, documents, IP assets in user specified projects and project objects). As noted above, data files and documentation may be organized such that they are stored based on the IP asset they relate to. However, organizing specific objects as belonging to user defined project objects may involve tagging the relevant objects as belonging to specific project objects. Determining which data objects belong to which project objects may involve the management module retrieving all data objects in the database that have been tagged with a specific project object tag. Accordingly, depending on the implementation, data files associated with a specific IP asset may be stored by the management module in such as way that the data files are stored with other data files associated with that specific IP asset. Similarly, user defined projects and project objects are created and organized by way of the management module and this may be implemented by simply tagging the relevant data objects with the relevant project object tags.

In another aspect, the system may be configured for use in sharing documentation with users external to the corporate organization whose assets are being managed by the system. It should be clear that the management module may organize the data files in the database using virtual folders, with data files and documentation relating to a common matter being stored in a single virtual folder. These virtual folders may be nested such that, for example, all documentation relating to a specific IP asset (e.g. a specific patent) is stored or detailed as being stored in a top virtual folder. Within that top virtual folder may be sub-folders for the patent application as filed, the prosecution of the specific patent, title related documentation for the specific patent, and any contracts or agreements that relate to or affect the specific patent. Similarly, the system may organize documentation relating to corporate matters in a similar way. Thus, the system may have virtual folders for topics/matters such as corporate documentation (e.g certificates of incorporation, stock certificates, minutes of corporate meetings, etc., etc.), agreements relating to the corporation, contracts entered into by the corporation, corporate financial matters, corporate director and corporate employee documentation, and corporate governance documentation. Thus, the management module may have virtual folders for any of the following matters: corporate documentation; financial documentation; corporate information relating to said predetermined organization; assets; agreements; contracts relating to employees; contracts relating to directors; contracts relating to consulting; capital assets; IP assets; liabilities; employment agreements; corporate records; and shareholder information.

With the data files being organized by the management module, the system also allows for the use of data rooms, i.e., virtual spaces that are associated with specific files or matters such that designated users (who may be external to the organization that runs/owns the IP managed by the system) are allowed controlled access to the files or matters. Thus a data room may have all the files relating to, for example, a specific IP asset but would not include any files relating to the directors of the corporation. Similarly, financial documentation may be in one data room designated for a potential venture capital funding round but not in a data room for assessing the company's IP portfolio.

As can be imagined, the system may have multiple data rooms as a user may create such data rooms (depending on the user's system permissions). Similarly, again dependent on the user's system permissions, a user may designate any document, data file, or virtual folder as being for inclusion in a specific data room. Once a data object (be it a document, data file, or virtual folder) has been selected by a user for that inclusion in a data room, the management module tags that data object as being in that specific data room. For clarity, this may cause data files stored under the data object (e.g. data files stored or designated as being in a virtual folder that has been selected by a user for inclusion in a data room) to also be tagged as being in the data room. Thus, if a user wishes to add all the relevant documentation relating to a specific IP asset to a data room, the user simply has to select the top level virtual folder for the specific IP asset for inclusion in a data room. This causes all the nested subfolders and documents and data files stored/designated as being within the top level folder to be designated as being in the data room. Of course, the level of granularity for sharing data files is dependent on the user. As an example, if the user only wishes to share one document from a whole virtual folder, the user simply has to select that one document for inclusion in the data room and nothing else from that virtual folder would be included in the data room.

The above capability easily allows users to create one or more data rooms for specific purposes. Thus, if the company is undergoing a due diligence prior to a corporate takeover (or a due diligence pursuant to a funding round), the user can simply find the documentation (in the database) needed for the due diligence, select such documentation for inclusion in a specific data room, and invite the relevant individuals involved in the due diligence to the data room. These relevant individuals can then review the documentation as necessary without having access to the rest of the data files stored in the system. Of course, as can be imagined, the user inviting the relevant individuals involved in the transaction to which the data room relates to, can set the permissions for the relevant individuals. This means that, as desired, the user can provide the relevant individuals with as much or as little controlled access to the documentation—the user simply has to set the relevant permissions (within the system) for the various individuals. The permissions determine how much access an external individual has—whether the external individual can view, download, or even edit the documentation. Of course, for some individuals involved in the transaction, only viewing privileges may be necessary. Other actions that may be permitted to external individuals include: viewing data files in said data room; downloading data files in said data room; editing data files in said data room; removing data files from said data room; and adding data files to said data room.

It should be clear that data rooms may be created for whatever purpose or transaction desired. Some of these transactions may include at least one of: government tax credits for at least one corporate organization; corporate financing for at least one corporate organization; a public offering of corporate stock in at least one corporate organization; venture capital funding for at least one corporate organization; and legal due diligence on at least one corporate organization.

Since multiple data rooms are possible, the user can create as many data rooms as needed. Thus, for example, data rooms may be created for specific transactions. The above due diligence is one example of such a transaction. As another example, a user may create a data room to share documentation for a government grant or a government tax credit program. Similarly the user may create a data room for a specific funding round or to share information and documentation with venture capitalist funds and/or banks. Once the data room has been created, the user can share the data room with whatever individuals may be involved in the transaction and the level of access to the documentation in the data room is controlled by the user using the permissions as noted above. Thus, the user can provide access to others without exposing the rest of the system to these others. The individuals to whom access may be granted include: lawyers; investors; accountants; venture capitalists; bankers; consultants; intellectual property specialists; specialists in corporate finance; tax specialists; technical subject matter experts; technology transfer specialists; inventors; creators of intellectual property; corporate officers; and government officials.

The data rooms may also be organized using virtual folders as necessary. Thus, a data room may have virtual folders for: data files relating to corporate records; data files relating to shareholder information; data files relating to financial matters; data files relating to employees of said predetermined organization; data files relating to directors of said predetermined organization; and data files relating to capital assets of said predetermined organization.

It is preferable that, when a user selects data files for inclusion in a data room, the user can also select the destination virtual folder in the data room. This causes the management module to not just tag the selected data file/data object as being in the data room but that the selected data file/data object is in a specific virtual folder in that specific data room.

As noted above, the system may provide guided suggestions for managing the IP of the organization. Thus, detailed and guided suggestions may be provided to the user based on the IP asset being managed, the stage at which the IP asset is at, as well as the budget allocated for that IP asset. In addition to this, the system may provide preconfigured templates to the user, with the preconfigured templates being for the management of the IP asset(s). Thus, preconfigured assignments, information disclosure statements, information disclosure forms (to detail an idea), preconfigured applications (e.g. a trademark application) may be provided to the user.

For security, it is preferable that the system be implemented in conjunction with a secure cloud-based storage. This allows for secure storage for the databases as well as ease of access to system users, both internal and external to the corporate organization using the system.

The overall system of the present invention thus provides a number of advantages to users and to the corporate organizations using it. Specifically, the system may be used for managing corporate matters and IP matters one or more corporate organizations. In one aspect, the management modules organizes the data files in the database into virtual folders such that data files in a specific virtual folder only relate to a matter common across the virtual folder (e.g. all documentation relating to a specific IP asset are stored in a top level folder dedicated to that specific IP asset). The system also tracks and manages relevant dates and deadlines for both corporate matters and for IP matters. Simply put, the system simplifies the management of both corporate and IP matters using a single system.

In addition to the above, the system allows for permission-based sharing of documentation across multiple organizations, even organizations that are external to the corporate organization whose IP and corporate matters are being managed by the system. As explained above, the permission-based sharing of documentation is accomplished by way of at least one specific data room. User selected data files tagged by the management module as being included in a data room are accessible to designated users across the multiple organizations. Sharing is made easy for the user as a user can share contents of a specific virtual folder with the select designated users by selecting the specific virtual folder as being included in a user specified data room. Thus, all the contents of the specific virtual folder are easily tagged as being in the specified data room.

The system also provides for automatic analysis of documentation for relevant deadlines and dates that are to be tracked. As well, the system provides multiple reports regarding corporate matters and IP matters based on data stored in the database. The form and content of these reports are user configurable/selectable. Importantly, when it comes to documentation, the system analyzes documentation for issues in the documentation content and can provide suggestions for addressing these issues. In one specific embodiment, the relevant dates and deadlines tracked by the system relate to an expiry of contract based rights, including IP based rights.

Additionally, the system can cover multiple organizations such that the multiple reports cover both corporate and IP matters for multiple corporations, partnerships, and business organizations. To simplify the management of such matters, the system can automatically retrieve data and documentation relating to these corporate and IP matters from at least one online source. Such data and documentation can be incorporated or addressed in one of the many reports available to the user.

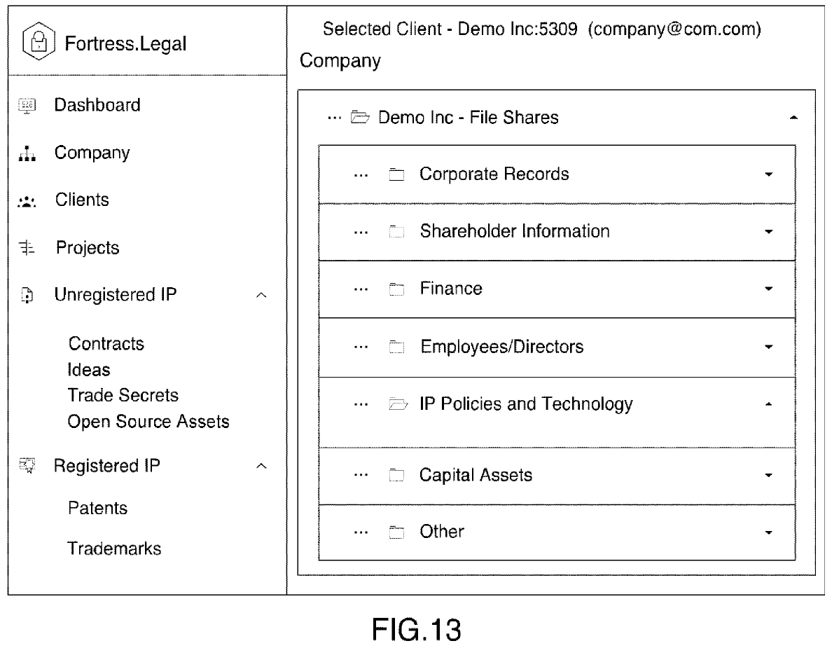

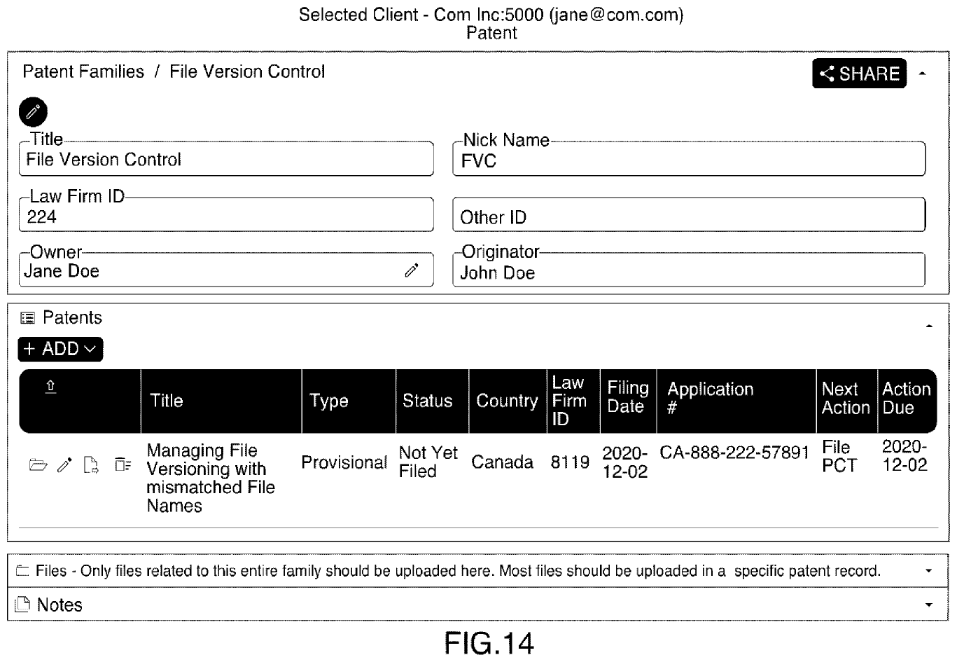

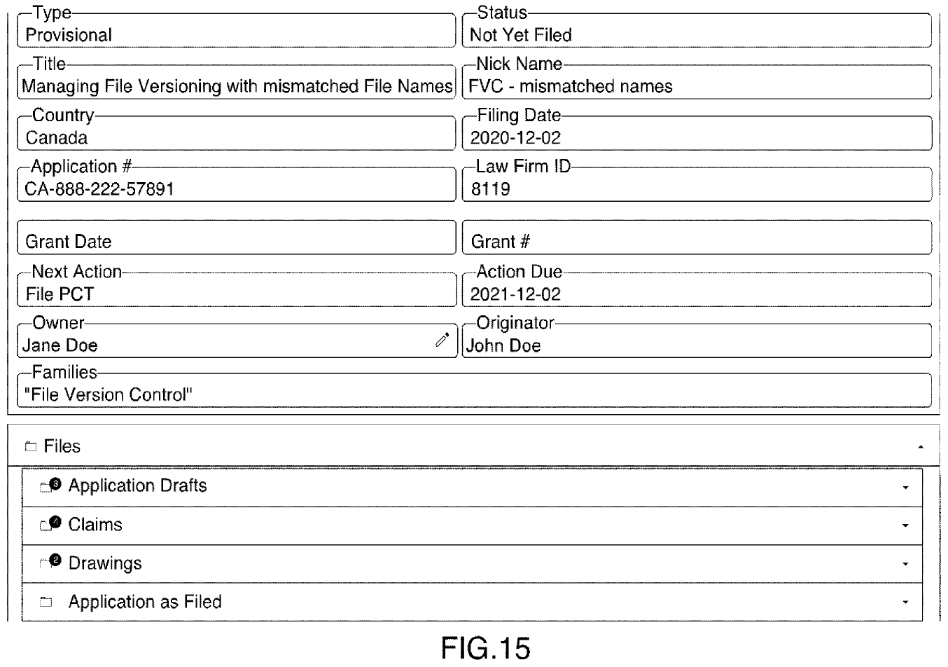

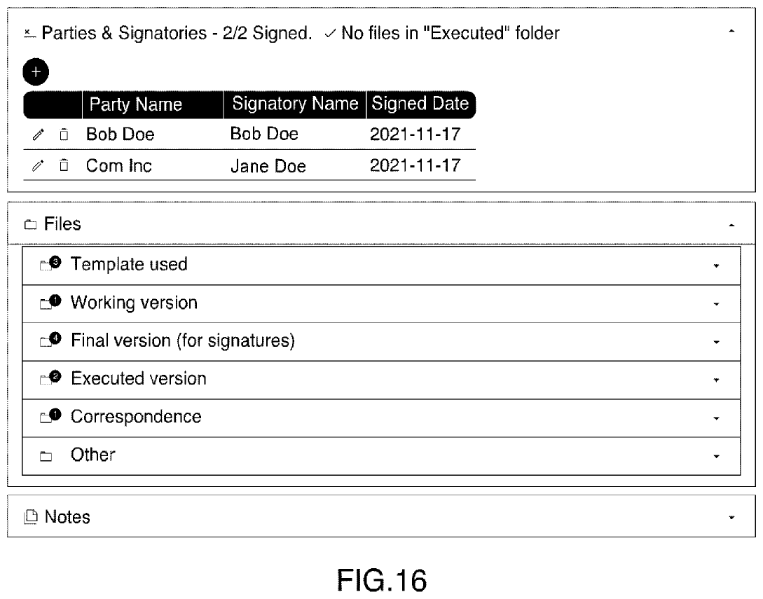

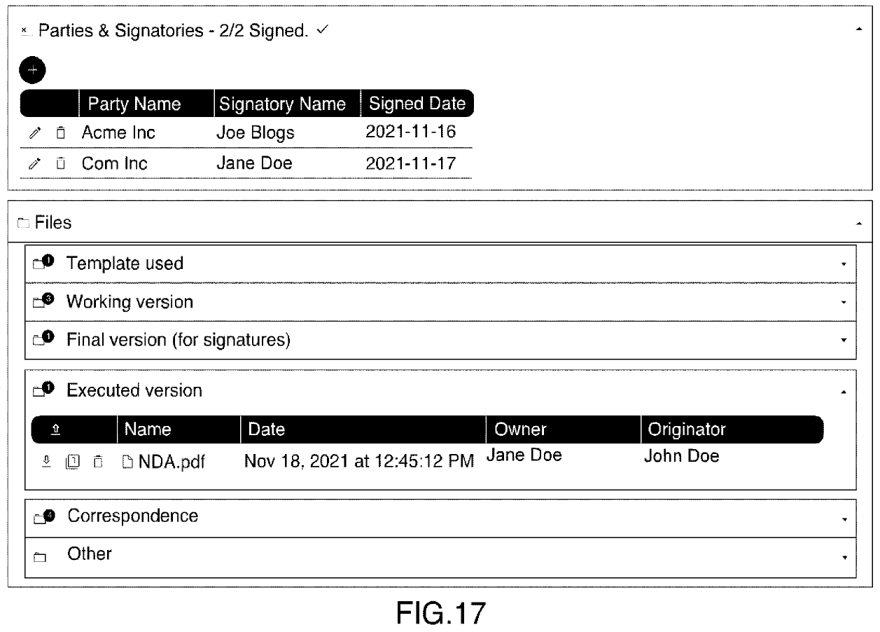

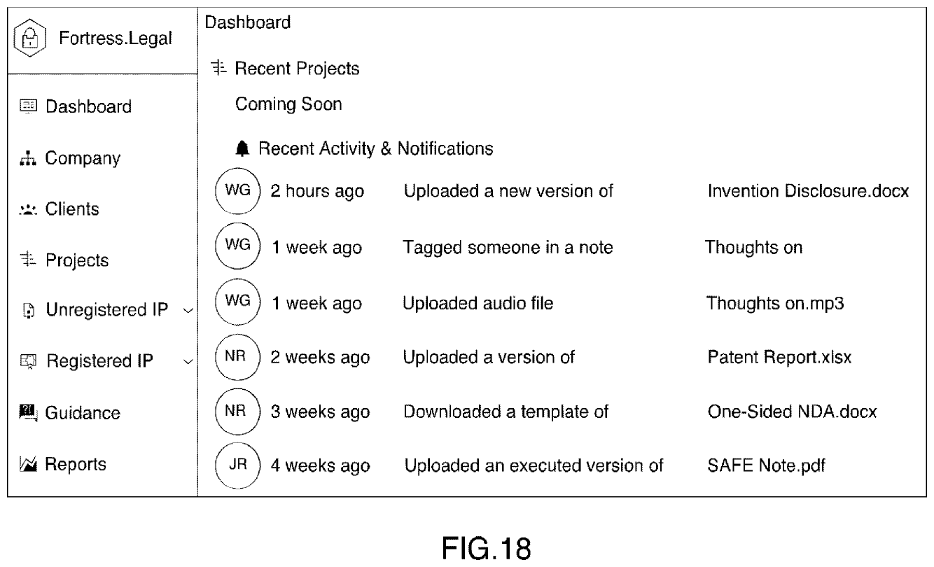

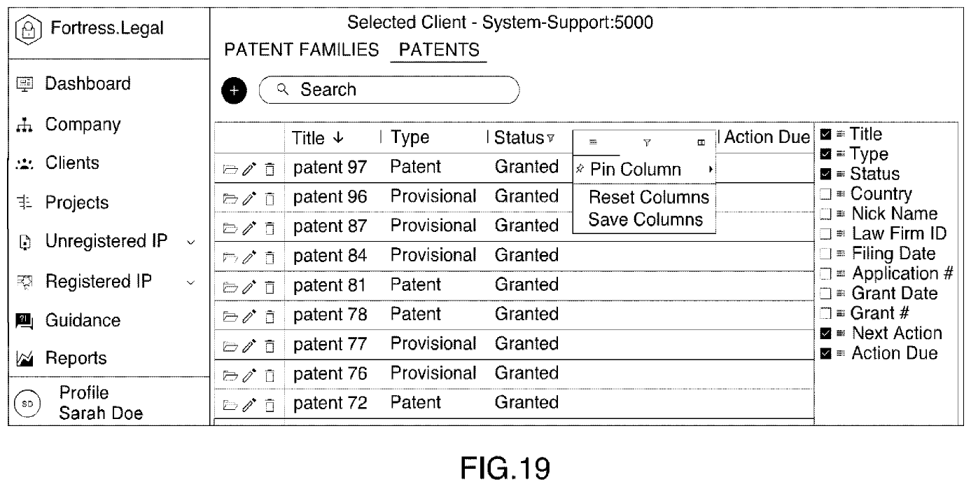

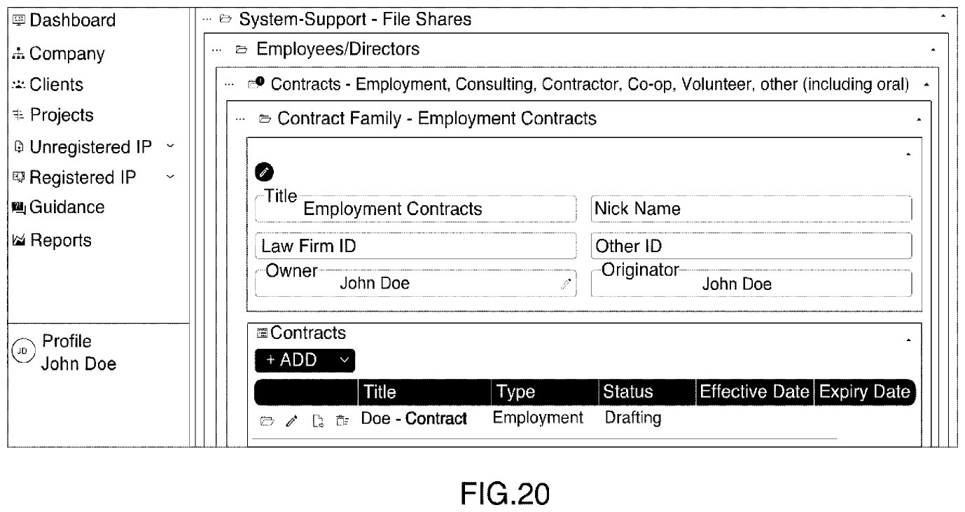

Referring to FIGS. 13-20, screenshots of a user interface illustrating various embodiments of the present invention. As can be seen, FIG. 13 shows the possible folders in a data room. To the left of the figure, categories of data stored in the system are also visible, including IP assets such as unregistered IP, registered IP, contracts, ideas, trade secrets, and open source assets. FIG. 14 shows a screenshot of a patent family view detailing the members of a patent family being tracked by the system. FIG. 15 shows a user interface for viewing a specific patent IP asset that is tracked by the system. As can be seen, the deadlines and the relevant data about the IP asset are detailed. Additionally, the various virtual subfolders for this IP asset are shown at the bottom of the figure. FIG. 16 shows a user interface for a contract being tracked by the system. As can be seen, subfolders for the template used for the contract, the working version of the contract, the final version for signatures, the executed version, and any correspondence relating to the contract are present. Additionally, the parties to the contract are detailed, along with their execution date for the contract. For FIG. 17, a similar user interface is shown for an executed Non-Disclosure Agreement. In FIG. 18, a dashboard screen for a system according to an embodiment of the present invention is detailed. As can be seen, recent activity on the system is detailed, along with when the activity occurred and what documentation was edited/uploaded/affected. In FIG. 19, a patent portfolio report is illustrated. As can be seen, the title of each patent is provided, along with the type of patent/patent application, and the status of each application. The report is customizable as the user can select the data points to be shown on the report (on the right of the figure). In FIG. 20, a screen shot of a data room detailing a family of contracts being shared is illustrated. As can be seen, each document is provided with the relevant information such as the title, the owner, and the originator of the document. A copy of the document is also provided.

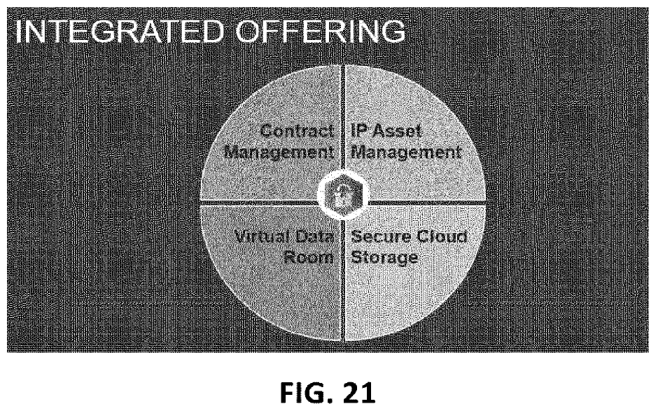

Referring to FIG. 21, it can thus be seen that the system of the present invention offers four distinct functions that have been integrated into a single holistic system. The system of the present invention provides contract management, including the tracking of contract expiry, the analysis of contract/agreement language, and even suggestions of preferred contract language/clauses. As well, the system of the present invention also provides IP asset management such as the management of ideas from innovators, the management of both registered and unregistered IP, the tracking of relevant deadlines and dates, and the generation of various reports relating to the IP assets being managed. Additionally, the system of the present invention provides for a secure virtual data room that allows for seamless and easy to configure sharing of selected data with individuals external to the organization. Thus, an organization using the present system can easily configure, provision, and populate data rooms for different uses such as due diligence, funding requirements (e.g. VC funding), audits, and asset/IP/corporate reviews. Finally, the present system provides for secure cloud storage as system users no longer have to worry about access, redundancy, and system security. The present system can be implemented as a secure cloud storage and can thus be accessible to anyone with a suitable Internet connection. This allows those doing audits and due diligence to easily review/assess the documentation remotely. Similarly, those managing the IP portfolio (e.g. an outside IP firm) can easily interface with the system to update records, upload documentation, and generally manage the IP portfolio. It should, of course, be possible that the system be implemented on an on-premise server for an organization. However, the secure nature of the system along with a public-facing networked portal allows for easy and seamless access to the system using a permissions based security model.

Note that the phrase “at least one of [x] and [y]”, as used herein, should be construed as meaning “[x], [y], or both [x] and [y]”. Further, any references herein to singular modules or units should be construed as encompassing the plural form.

In another aspect, the present invention provides a system for managing intellectual property rights, said system comprising:
a user interface configured to receive input from a user, wherein the information comprises at least one of a transaction document and a data file relating to an idea;
a processor for receiving said input from said user interface, the processor comprising:
   an ideation module for providing information relating to an ideation process, wherein, when said input comprises said data file relating to an idea:
      said ideation module identifies at least one key word in said at least one data file, said at least one key word being added to said at least one data file by at least one user and said at least one key root word being identified based on predetermined trigger data in said at least one data file, wherein the at least one key word is either: at least a part of a trademark or a term that characterizes an invention based on the idea; and
      said ideation module causes said user interface to display intellectual property information relating to said at least one key word to said user, wherein said intellectual property information is retrieved from an intellectual property database that stores intellectual property information,
   a documentation analysis module for identifying at least one of: a risk in said transaction document and a change from a previous version of said transaction document, wherein, when said input comprises said transaction document:
      said documentation analysis module identifies at least one of: a presence of at least one transaction term in a document in the least one file, said at least one transaction term being a match with a term derived from at least one root word in a plurality of key root words, wherein each root word in said plurality is associated with transaction language used in transaction documentation or with a transaction risk that is a consequence of said transaction language; an absence of said at least one transaction term; and said change, and
      said documentation analysis module causes said user interface to display at least one of: preferred transaction language associated with said at least one transaction term; an indication of said transaction risk based on said presence or said absence of said at least one transaction term; and said change, and
a database in communication with said processor, said database being for storing at least: said input; said plurality of key root words; and said at least one key word;
wherein said input comprises a first transaction documentation file a second transaction documentation file and wherein:
said documentation analysis module identifies at least one change in language between said first transaction documentation file and said second transaction documentation file, wherein said at least one change is related to at least one specific key root word; and
changed language in said second transaction documentation file that is related to said at least one change is flagged as specific preferred language to be associated with said at least one specific key root word; and
wherein said input further comprises a third transaction documentation file and wherein, when said documentation analysis module identifies a presence or an absence of said specific preferred language in said third transaction documentation file, said documentation analysis module causes said user interface to present said specific preferred language to said user; and
wherein said second transaction documentation file is a later version of said first transaction documentation file.

In another aspect, this document discloses a system for managing transaction documentation, the system comprising:
a user interface for uploading a data file related to said transaction documentation and for reviewing said at least one data file;
a server for receiving said data file; and
a database for storing said data file,
   wherein, when a defect in said at least one data file is flagged, said system prompts at least one user to resolve said defect.

In another embodiment, this document discloses a system wherein said defect is flagged by an expert user, said expert user having expertise related to the defect. In another embodiment, this document discloses a system wherein said defect is flagged by the server.

In another aspect, this document discloses a system for marking projects for review by third parties, the system comprising:
a user interface for uploading at least one data file and for reviewing said at least one data file;
a server for receiving said at least one data file;
a first database for storing said at least one data file; and
a second database for storing information for said review, said second database being accessible by said third parties,
   wherein said at least one data file relates to a project, said project relating to at least one of: an idea; a product; a service; and a transaction,
   wherein said project is managed by an organization and said first database contains a record of said organization,
   wherein multiple data files relating to a single project are linked to each other within said first database, such that said multiple data files together form a project object,
   wherein, when a user marks at least a part of said project object for review, a reference to said at least a part of said project object is added to said second database,
   and wherein, when a user marks said record of said organization for review, a second reference to said organization is added to said second database.

In another embodiment, this document discloses a system wherein said at least one data file represents a legal instrument that is one of: a patent, a trademark, a design, a copyright registration, and another intellectual property asset.

In another embodiment, this document discloses a system wherein the project object represents a legal instrument that is one of: a patent, a trademark, a design, a copyright registration, and another intellectual property asset.

It should be clear that various aspects of the present invention may be implemented as software modules in an overall software system. As such, the present invention may thus take the form of computer executable instructions that, when executed, implements various software modules with predefined functions.

Embodiments of the invention may be executed by a computer processor or similar device programmed in the manner of method steps or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C #”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

1. A system for managing IP assets and data files, said data files being associated with at least one IP asset being managed, the system comprising:
a user interface module for receiving input from a user and for uploading at least one data file and for reviewing said at least one data file;
a server for receiving said at least one data file; and
a first database for storing said at least one data file,
a management module for managing said data files and document files, said document files being a specific type of data file;
a document analysis module for analyzing a content of document files;
wherein
each data file relates to at least one IP asset being managed by said system;
said management module organizes said data files based on user defined project groupings;
data files organized into a specific project grouping are linked to one another and said data files organized into a project grouping forms a project object;
each project grouping relates to at least one of: a specific idea, a specific product, a specific service, and a specific transaction.

2. The system according to claim 1, wherein said at least one data file is linked to at least one relevant project object.

3. The system according to claim 1, wherein said user interface is integrated with at least one third party application on a computing device used by a user, such that data files are uploadable to said system directly from said at least one third party application.

4. The system according to claim 1, wherein each project object is accessible by multiple users.

5. The system according to claim 4, wherein said project object has at least one controlling user and wherein said at least one controlling user designates other users that are permitted to access said project object and to access each data file within said project object.

6. The system according to claim 5, wherein said at least one controlling user designates other users that are permitted to modify said project object and to modify each data file within said project object.

7. The system according to claim 1, wherein said at least one data file is downloadable to a computing device used by a user.

8. The system according to claim 1, wherein at least one issue related to said at least one data file is flagged by a user.

9. The system according to claim 8, wherein, when said at least one issue is flagged, a system notification that prompts at least one user to resolve said at least one issue is generated.

10. The system according to claim 1, wherein said project object includes at least one of: a data file relating to an intellectual property asset; a data file relating to a product; a data file relating to a service; and a data file relating to a transaction.

11. The system according to claim 1, wherein a visual representation of said data files comprising said project object is presented to a user through said user interface.

12. The system according to claim 1, wherein at least a part of said project object is marked by a user for review by a third party, said system further comprising a second database, and wherein, when said at least a part of said project object is marked by said user, a reference to said at least part of said project object is added to said second database.

13. The system according to claim 1, wherein said system further comprises at least one of:
a timeline reporting module for generating timelines and timeline-based reports based on data retrieved from said database;
a document analysis module for analyzing documents stored in said database;
an ideation module for assisting users in documenting ideas such that said ideas are documented in data files stored in said database;
a docketing module for tracking dates and deadlines for IP assets being managed;
an automated searching module for providing automated searching functions for relevant patent and trademark documentation based on user inputs;
a budgeting module for providing cost estimates for specific IP related actions;
a reporting module for creating and managing reports on IP assets being managed by said system; and
a data extraction module for analyzing documentation stored in said database and for extracting relevant data from said documentation.

14. A system for managing IP assets, said system comprising:
a user interface for uploading at least one data file and for reviewing said at least one data file;
a server for receiving said at least one data file; and
a cloud-based data storage space for storing said at least one data file,
wherein metadata related to said at least one data file is also stored in the data storage space,
wherein said system further comprises a reporting module for generating a tracking report related to said metadata, said report being presented to a user,
and wherein said at least one data file relates to an IP asset being managed by said system.

15. The system according to claim 14, wherein said metadata is at least one of: extracted from said at least one data file and input by a user of said user interface.

16. The system according to claim 14, wherein said at least one data file is linked to at least one other data file to thereby form a project object and wherein said report relates to said project object.

17. A method for generating timeline visualizations, said method comprising:
receiving a plurality of dates related to a plurality of milestone events;
determining at least one period based on at least one pair of dates, at least one of said at least one pair of dates being one of said plurality of dates;
generating a timeline visualization, said timeline visualization being a visual representation of said at least one period.

18. The method according to claim 17, wherein said timeline visualization is interactive.

19. The method according to claim 18, wherein said timeline visualization displays at least one milestone event, said at least one milestone event being related to an IP asset.

20. The method according to claim 19, wherein said at least one milestone event relates to at least one of:
government regulations;
an IP asset related deadline;
a filing date;
a priority date;
a date of publication;
a grant date;
an approval date;
a product launch date;
an implementation date;
an expiry of IP related rights;
an expiry of license rights; and
an expiry of exclusivity rights.

21. The system according to claim 13, wherein said system tracks deadlines for an expiry of licensed IP related rights.

22. The system according to claim 1, wherein said IP assets include at least one of:
issued patents;
unfiled patent applications;
filed patent applications;
pending patent applications;
registered rights to specific ideas;
unregistered rights to specific ideas;
registered trademarks;
pending trademark applications;
unregistered trademarks;
registered industrial designs;
pending industrial design applications;
unregistered industrial designs;
rights to materials covered by copyright;
trade secrets;
open source licenses;
agreements;
contracts;
assignments;
licenses;
licenses covering IP rights;
employment agreements; and
rights to specific technologies.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)
